(19) United States
(12) Patent Application Publication
(10) Pub. No.: US 2020/0380775 A1
(43) Pub. Date: Dec. 3, 2020

(54) TRANSMITTING DEVICE, TRANSMITTING METHOD, AND RECEIVING DEVICE

(71) Applicant: SONY CORPORATION, Tokyo (JP)

(72) Inventors: Yuichi ARAKI, Tokyo (JP); Junichi TANAKA, Kanagawa (JP)

(73) Assignee: SONY CORPORATION, Tokyo (JP)

(21) Appl. No.: 16/766,478

(22) PCT Filed: Nov. 16, 2018
(86) PCT No.: PCT/JP2018/042427

§ 371 Date: May 22, 2020

(30) Foreign Application Priority Data
Dec. 1, 2017 (JP) 2017-231795

(51) Int. Cl. G06T 17/20; H04N 19/597; G06T 9/00

(52) U.S. Cl. CPC G06T 17/20; G06T 9/001; H04N 19/597

(57) ABSTRACT

There is provided a transmitting device, a transmitting method, and a receiving device that enables generation of 3D data. A flag generating device generates information based on the degree of difference between two frames of a 3D image. The transmitting device transmits information based on the generated degree of difference. The present technology can be applied to, for example, a transmitting device or the like that transfers 3D image data.

### TECHNICAL FIELD

The present technology relates to a transmitting device, a transmitting method, and a receiving device, and in particular, relates to a transmitting device, a transmitting method, and a receiving device related to generation of 3D data.

### BACKGROUND ART

In the case of transferring 3D shape data (3D data) to a terminal of a viewing user and displaying the 3D data, in order to reproduce smooth motion, a higher frame rate is preferable; however, at present, generation of 3D data with a high frame rate is difficult in some cases.

Therefore, it is conceivable to generate 3D data with a higher frame rate by up-converting generated 3D data with a lower frame rate.

For example, Non-Patent Document 1 proposes a technology of generating a vertex position of frames between adjacent frames by using bidirectional interpolation from mesh data of a 2D image generated on the adjacent frames, and generating 3D data with a higher frame rate (for example, see Non-Patent Document 1).

### CITATION LIST

### Non-Patent Document

Non-Patent Document 1: Kyung-Yeon Min, Jong-Hyun Ma, and Dong-Gyu Sim (Kwangwoon University), Ivan V. Bajic (Simon Fraser University), “Bidirectional Mesh-Based Frame Rate Up-Conversion”, IEEE Computer Society, 2015

### SUMMARY OF THE INVENTION

### Problems to be Solved by the Invention

However, since the technology of Non-Patent Document 1 is a 2D image-based interpolation process, the technology cannot cope with 3D shape self-occlusion.

The present technology has been made in view of such a situation, and enables generation of 3D data.

### Solution to Problems

A transmitting device according to a first aspect of the present technology includes an information generating unit that generates information based on degree of difference between two frames of a 3D image, and a transmitting unit that transmits the information based on the degree of difference generated.

In a transmitting method according to a first aspect of the present technology, a transmitting device generates information based on degree of difference between two frames of a 3D image, and transmits the information based on the degree of difference generated.

In the first aspect of the present technology, information based on degree of difference between two frames of a 3D image is generated and transmitted.

A receiving device according to a second aspect of the present technology includes an image generating unit that generates an interpolated frame between two frames of a 3D image by an interpolated frame generating process on the basis of information based on degree of difference between the two frames.

In the second aspect of the present technology, an interpolated frame between two frames of a 3D image is generated in an interpolated frame generating process on the basis of information based on degree of difference between the two frames.

Note that the transmitting device according to the first aspect and the receiving device according to the second aspect of the present technology can be realized by causing a computer to execute a program.

Furthermore, in order to realize the transmitting device according to the first aspect of the present technology and the receiving device according to the second aspect of the present technology, a program to be executed by a computer is transferred through a transfer medium or is recorded on a recording medium so as to be able to be provided.

The transmitting device and the receiving device may be independent devices, or may be internal blocks constituting one device.

### Effects of the Invention

According to the first aspect of the present technology, 3D data can be generated on the receiving side that receives data.

Furthermore, according to the second aspect of the present technology, 3D data can be generated.

Note that the effects described here is not necessarily limited, and may be any effect described in the present disclosure.

### BRIEF DESCRIPTION OF DRAWINGS

FIG. 1 is a block diagram illustrating a configuration example of a first embodiment of an image processing system to which the present technology is applied.

FIG. 2 is a diagram explaining a process from imaging to generation of 3D data.

FIG. 3 is a diagram explaining a mesh tracking process.

FIG. 4 is a diagram explaining an interpolation process.

FIG. 5 is a diagram explaining an interpolated frame generating process performed by an image generating device.

FIG. 6 is a diagram explaining an interpolated frame generating process performed by the image generating device.

FIG. 7 is a flowchart explaining a key frame flag generating process.

FIG. 8 is a diagram explaining key frame flag storing processes.

FIG. 9 is a flowchart explaining the key frame flag storing process of A in FIG. 8.

FIG. 10 is a flowchart explaining the key frame flag storing process of B in FIG. 8.

FIG. 11 is a flowchart explaining a key frame flag separating process of A in FIG. 8.

FIG. 12 is a flowchart explaining a key frame flag separating process of B in FIG. 8.

FIG. 13 is a flowchart explaining an interpolated frame generating process.

FIG. 14 is a flowchart explaining an interpolation process.

FIG. 15 is a flowchart explaining a transfer data transmitting process.

FIG. 16 is a flowchart explaining a transfer data receiving process.

FIG. 17 is a flowchart explaining an interpolation type generating process.

FIG. 18 is a flowchart explaining an interpolated frame generating process in a case where an interpolation type is transferred.

FIG. 19 is a block diagram illustrating a configuration example of a second embodiment of an image processing system to which the present technology is applied.

FIG. 20 is a block diagram illustrating a configuration example of a third embodiment of an image processing system to which the present technology is applied.

FIG. 21 is a flowchart explaining a key frame flag estimating process.

FIG. 22 is a block diagram illustrating a configuration example of a fourth embodiment of an image processing system to which the present technology is applied.

FIG. 23 is a diagram explaining an interpolated frame generating process.

FIG. 24 is a flowchart explaining a hybrid interpolated frame generating process.

FIG. 25 is a flowchart explaining an interpolation type generating process in a case where an interpolation type is used.

FIG. 26 is a flowchart explaining a hybrid interpolated frame generating process in a case where an interpolation type is used.

FIG. 27 is a block diagram illustrating a configuration example of a fifth embodiment of an image processing system to which the present technology is applied.

FIG. 28 is a block diagram illustrating a configuration example of a sixth embodiment of an image processing system to which the present technology is applied.

FIG. 29 is a block diagram illustrating a configuration example of a seventh embodiment of an image processing system to which the present technology is applied.

FIG. 30 is a block diagram illustrating a configuration example of an eighth embodiment of an image processing system to which the present technology is applied.

FIG. 31 is a block diagram illustrating a configuration example of an embodiment of a computer to which the present technology is applied.

### MODE FOR CARRYING OUT THE INVENTION

Hereinafter, embodiments for implementing the present technology (hereinafter, referred to as embodiments) will be described. Note that the description will be given in the following order.

1. First Embodiment of Image Processing System (Basic Configuration Example)

2. Key Frame Flag Generating Process

3. Key Frame Flag Storing Process

4. Key Frame Flag Separating Process

5. Interpolated Frame Generating Process

6. Interpolation Process

7. Transfer Data Transmitting Process

8. Transfer Data Receiving Process

9. Example Using Interpolation Type

10. Second Embodiment of Image Processing System (Configuration Example Without Compression Coding)

11. Third Embodiment of Image Processing System (Configuration Example Not Transmitting Key Frame Flag)

12. Fourth Embodiment of Image Processing System (Hybrid Configuration Example)

13. Hybrid Interpolated Frame Generating process

14. Example Using Interpolation Type

15. Fifth Embodiment of Image Processing System (Example of Hybrid Configuration not Performing Compression Coding)

16. Sixth Embodiment of Image Processing System (Configuration Example Not Transmitting Key Frame Flag)

17. Seventh Embodiment of Image Processing System (Modification of Hybrid Configuration)

18. Eighth Embodiment of Image Processing System (Modification of Basic Configuration)

19. Computer Configuration Example

<1. First Embodiment of Image Processing System>

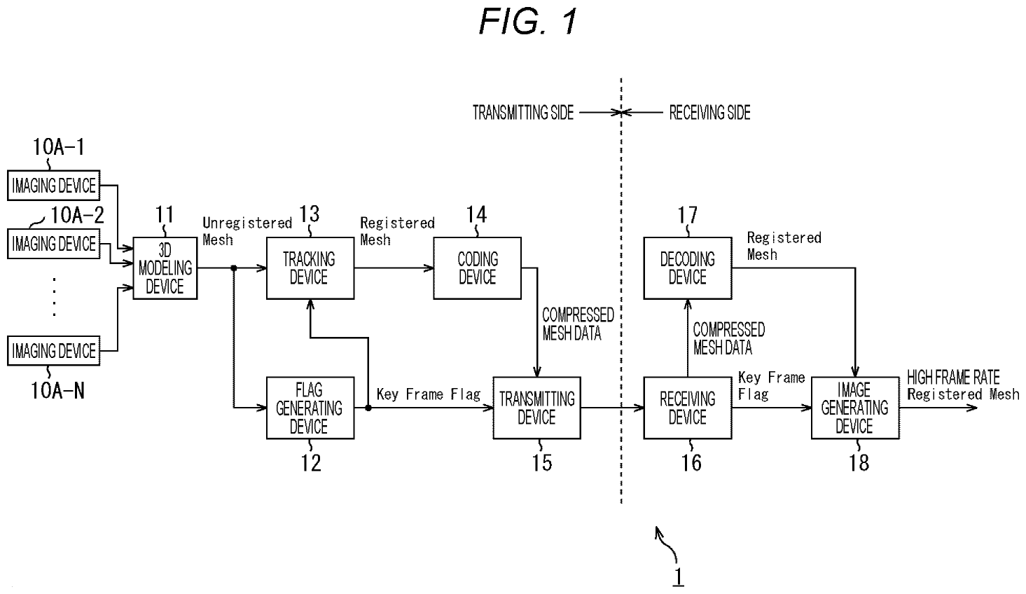

FIG. 1 is a block diagram illustrating a configuration example of a first embodiment of an image processing system to which the present technology is applied.

The image processing system 1 in FIG. 1 is a system including a transmitting side of transmitting 3D shape data (3D data) generated by imaging a subject, and a receiving side of generating 3D data with a higher frame rate from the 3D data transmitted from the transmitting side. The transmitting side transfers, to the receiving side, information for up-converting the 3D data to be transmitted to a high frame rate, specifically, 3D data to which information based on the degree of difference between two frames is added. The receiving side up-converts the received 3D data to a high frame rate by using information based on the degree of difference between the two frames.

The image processing system 1 includes a plurality of imaging devices 10A-1 to 10A-N (N>1), a 3D modeling device 11, a flag generating device 12, a tracking device 13, a coding device 14, a transmitting device 15, a receiving device 16, a decoding device 17, and an image generating device 18.

The transmitting side corresponds to the plurality of imaging devices 10A-1 to 10A-N, the 3D modeling device 11, the flag generating device 12, the tracking device 13, the coding device 14, and the transmitting device 15. The receiving side corresponds to the receiving device 16, the decoding device 17, and the image generating device 18. In a case where it is not necessary to particularly distinguish the plurality of imaging devices 10A-1 to 10A-N from each other, each of the plurality of imaging devices 10A-1 to 10A-N is simply referred to as an imaging device 10A.

The imaging device 10A includes either a passive camera or an active camera (active sensor).

In a case where the imaging device 10A includes a passive camera, the imaging device 10A images a subject, generates a texture image (RGB image) as a result, and supplies the texture image (RGB image) to the 3D modeling device 11.

In a case where the imaging device 10A includes an active camera, the imaging device 10A generates a texture image similar to that generated by the passive camera, emits IR light, receives the IR light reflected and returned from the subject, and thus generates an IR image and supplies the IR image to the 3D modeling device 11. Furthermore, the imaging device 10A measures the distance to the subject from the received IR light, generates a depth image in which the distance to the subject is stored as a depth value, and supplies the depth image to the 3D modeling device 11.

The plurality of imaging devices 10A synchronously images the subject, and supply the captured images obtained as a result to the 3D modeling device 11. Here, in a case where the imaging device 10A includes a passive camera, captured images obtained by imaging with the imaging device 10A are only texture images. In a case where the imaging device 10A includes an active camera, captured images are texture images, IR images, and depth images. Furthermore, a captured image includes a moving image.

The 3D modeling device 11 performs a 3D shape modeling process of the subject on the basis of the captured images obtained by the respective plurality of imaging devices 10A, and supplies the 3D shape data (3D data) obtained as a result of the modeling process to the tracking device 13 and the flag generating device 12.

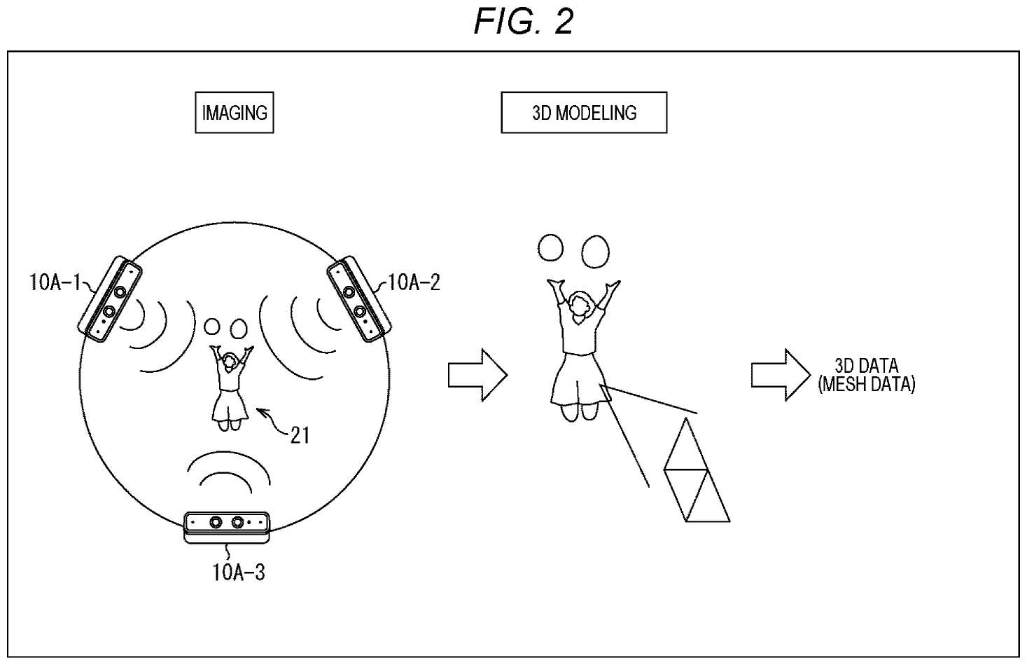

FIG. 2 is a diagram explaining processes from imaging by the plurality of imaging devices 10A to generation of 3D data by the 3D modeling device 11.

The plurality of imaging devices 10A is arranged outside a subject 21 so as to surround the subject 21, as illustrated in FIG. 2. FIG. 2 illustrates an example in which the number of imaging devices 10A is three, and the imaging devices 10A-1 to 10A-3 are arranged around the subject 21.

The 3D modeling device 11 generates 3D data using captured images captured by the three imaging devices 10A-1 to 10A-3 in synchronization. The 3D data is represented, for example, in a form of mesh data in which geometry information of the subject 21 is represented by connection between vertices (vertex) called a polygon mesh, and color information in association with each polygon mesh. This form is a form standardized by MPEG-4 Part 16 (Animation Framework eXtension) AFX. Note that the 3D data may be in another form, for example, a form in which the three-dimensional position of the subject 21 is a set of points (point cloud), color information is stored in association with each point, and the like.

The process of generating 3D data from the captured images obtained by the plurality of imaging devices 10A is also called 3D reconstruction (process).

Returning to FIG. 1, the flag generating device 12 judges, in units of frames, whether or not the 3D shape greatly changes between successive two frames in the 3D data from the 3D modeling device 11, and supplies the judgment result as a key frame flag to the tracking device 13 and the transmitting device 15. The key frame flag is information based on the degree of difference between two frames. For example, in a case where the key frame flag of a certain frame is “1”, the frame is a key frame, that is, is a frame whose 3D shape has greatly changed from the previous frame. In a case where the key frame flag is “0”, the frame is not a key frame.

The flag generating device 12 is supplied with mesh data of polygon meshes and 3D data in a form having color information in association with each polygon mesh.

The flag generating device 12 calculates the degree of difference between the mesh data of two adjacent frames, sets the key frame flag to “1” in a case where the calculated degree of difference is greater than a predetermined threshold, and sets the key frame flag to “0” in a case where the calculated degree of difference is not greater than the predetermined threshold.

The degree of difference between the mesh data of two adjacent frames can be calculated by using, for example, the Hausdorff distance of the following Expression (1).

[Mathematical Expression 1]

h(A,B)=max_{a∈A}{min_{b∈B}{d(a,b)}} (1)

The set A in Expression (1) includes respective vertices of the mesh data of one of the two adjacent frames, and the set B includes respective vertices of the mesh data of the other frame. As the Hausdorff distance of the Expression (1), the maximum value of the shortest distances from the vertices included in the set A to the set B is calculated.

The tracking device 13 executes a mesh tracking process on the mesh data of each frame supplied as 3D data from the 3D modeling device 11, and supplies the mesh data subjected to the mesh tracking process to the coding device 14.

In addition, the tracking device 13 is supplied with a key frame flag indicating whether or not the 3D shape greatly changes in the successive two frames from the flag generating device 12 in units of frames.

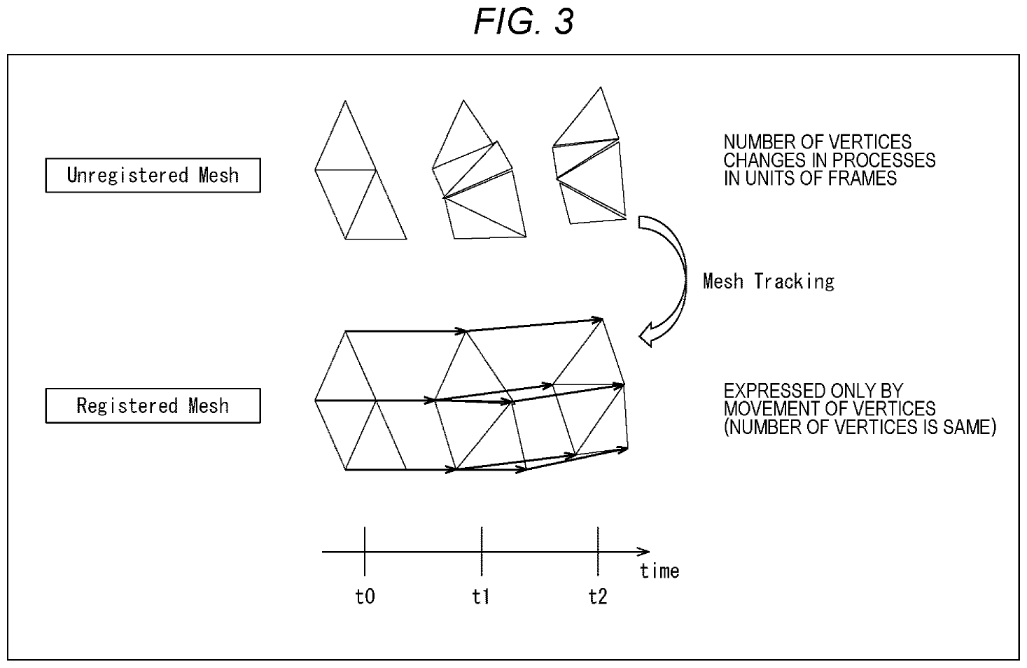

FIG. 3 is a diagram illustrating a mesh tracking process performed by the tracking device 13.

Note that in the following, mesh data of each frame before subjected to the mesh tracking process supplied from the tracking device 13 is also referred to as an U mesh, which is an abbreviation of unregistered mesh (Unregistered Mesh), and mesh data of each frame after subjected to the mesh tracking process and output from the tracking device 13 is referred to as an R mesh, which is an abbreviation of registered mesh (Registered Mesh). Furthermore, a simple expression “mesh” means an unregistered mesh.

In the U mesh generated by the 3D modeling device 11, since correspondence of vertices between frames are not considered, the vertices do not correspond to each other between frames. Therefore, for example, the number of vertices is different for each frame in some cases.

In contrast, in the mesh tracking process, the corresponding vertices are searched for and determined between successive frames. Therefore, in the R mesh, the positions of the vertices correspond with each other between the frames, and the number of vertices in the respective frames are identical. In this case, movement of the subject 21 can be expressed only by movement of the vertices.

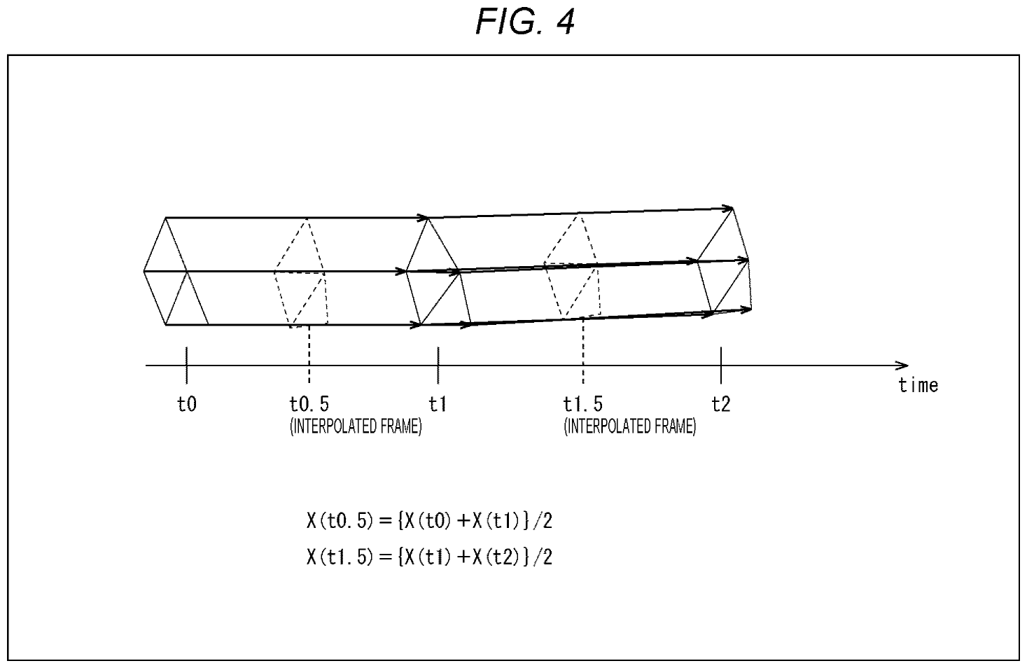

In the R mesh, the positions of the vertices correspond to each other between the frames. Therefore, as illustrated in FIG. 4, it is possible to obtain the R mesh of the frame between the R meshes of two adjacent known frames by using an interpolation process.

FIG. 4 illustrates how the R mesh of the frame at time point t0.5 between time point t0 and time point t1 is obtained by using an interpolation process, and the R mesh of the frame at time point t1.5 between time point t1 and time point t2 is obtained by an interpolation process.

Returning to FIG. 1, regarding the frame with the key frame flag “0” supplied from the flag generating device 12, the tracking device 13 performs the mesh tracking process on mesh data of a frame at a time point before the frame with the key frame flag “0”, and supplies the mesh data subjected to the mesh tracking process to the coding device 14.

In contrast, regarding frame with the key frame flag “1” supplied from the flag generating device 12, since correspondence with the mesh data of the frame at the previous time point cannot be made, the tracking device 13 supplies the U mesh to the coding device 14 as it is as an R mesh.

The coding device 14 compresses and codes the R mesh of each frame supplied from the tracking device 13 by using a predetermined coding system. The compressed mesh data of each frame obtained by compression coding is supplied to the transmitting device 15. For example, for compression encoding of the R mesh, Frame-based Animated Mesh Coding (FAMC), which is one of the tools standardized as MPEG-4 Part 16 Animation Framework eXtenstion (AFX) can be adopted for compression coding of an R mesh. Scalable Complexity 3D Mesh Compression (SC-3DMC) can be adopted for compression coding of a U mesh.

The transmitting device 15 causes the compressed mesh data of each frame supplied from the coding device 14 and the key frame flag of each frame supplied from the flag generating device 12 to be stored in one bit stream, and transmits the bit stream to the receiving device 16 via a network. The network includes, for example, a leased line network such as various local area networks (LANs), wide area networks (WANs), or the IP-VPNs (Internet Protocol-Virtual Private Networks), or the like including the Internet, a telephone network, a satellite communication network, and Ethernet (registered trademark), or the like.

The receiving device 16 receives a bit stream of 3D data transmitted from the transmitting device 15 via the network. Then, the receiving device 16 separates the compressed mesh data of each frame and the key frame flag of each frame, stored in the received bit stream of the 3D data from each other, supplies the compressed mesh data of each frame to the decoding device 17, and supplies the key frame flag of each frame to the image generating device 18.

The decoding device 17 decodes the compressed mesh data of each frame supplied from the receiving device 16 by using a system corresponding to the coding system in the coding device 14. The decoding device 17 supplies the R mesh of each frame obtained by decoding to the image generating device 18.

The image generating device 18 uses the R mesh of each frame supplied from the decoding device 17 and the key frame flag of each frame supplied from the receiving device 16 to perform an interpolated frame generating process of generating an interpolated frame to be interpolated between the respective frames supplied from the receiving device 16. Therefore, the image generating device 18 generates 3D data whose frame rate is up-converted. More specifically, the image generating device 18 generates the R mesh of a newly generated interpolated frame by an interpolation process between the respective frames supplied from the decoding device 17 on the basis of the key frame flags of the respective frames, generates mesh data with a higher frame rate than that of the received mesh data, and outputs the generated mesh data to a subsequent device. The subsequent device includes, for example, a drawing device or the like that generates a 3D image on the basis of the supplied mesh data and displays the 3D image on a display.

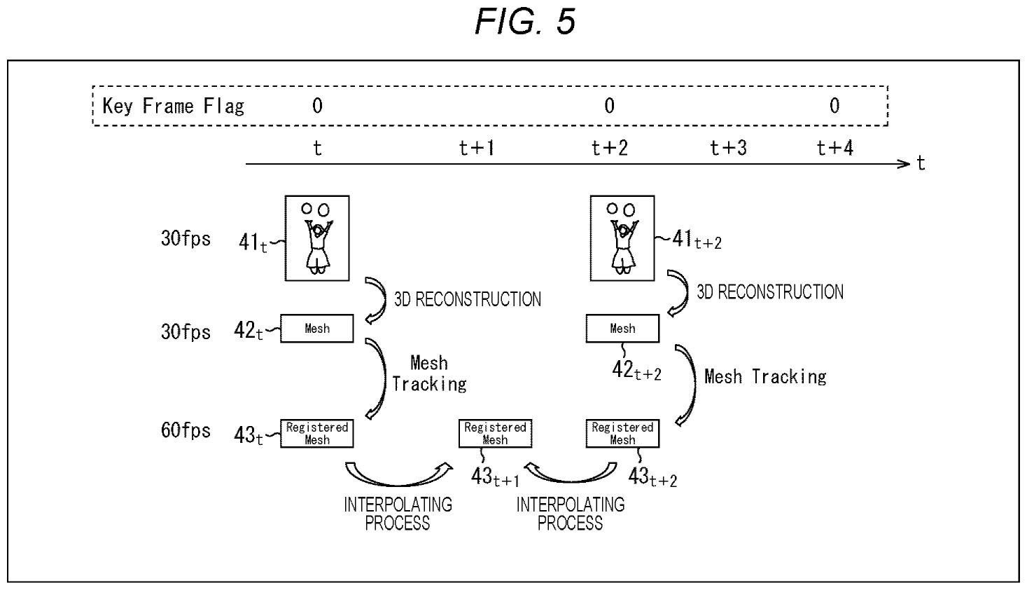

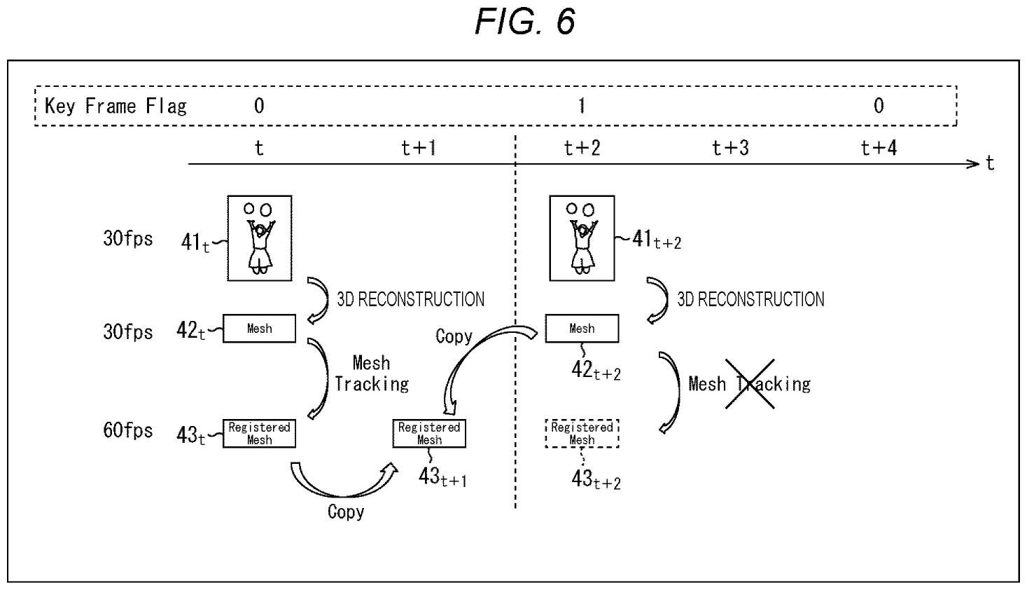

An interpolated frame generating process performed by the image generating device 18 will be described with reference to FIGS. 5 and 6.

In FIGS. 5 and 6, a case will be described where the frame rate of each of the U mesh and the R mesh generated from the captured images obtained by the plurality of imaging devices 10A is 30 frames per second (fps), and an R mesh with 60 fps is generated by using the interpolated frame generating process.

FIG. 5 is a diagram illustrating an interpolated frame generating process in a case where the key frame flag is “0”, that is, the 3D shape have not significantly changed between successive frames.

In the 3D modeling device 11, a U mesh 42 is generated for each frame from the captured images 41 obtained by the plurality of imaging devices 10A. Then, in the tracking device 13, the U mesh 42 is converted into an R mesh 43, and the R mesh 43 with 30 fps is transferred from the transmitting side to the receiving side.

In FIG. 5, captured images 41 with 30 fps obtained by the plurality of imaging devices 10A are captured images 41ₜ, 41ₜ₊₂, . . . , the U meshes 42 with 30 fps generated by the 3D modeling device 11 are U meshes 42ₜ, 42ₜ₊₂, . . . , and the R meshes 43 converted by the tracking device 13 are R meshes 43ₜ, 43ₜ₊₂, . . . . Each of the subscripts t, t+2, . . . in the captured images 41ₜ, 41ₜ₊₂ indicates the time point at which the captured image 41 was obtained. The U mesh 42 and the R mesh 43 are similar.

The image generating device 18 generates the R mesh 43 with 60 fps from the R mesh 43 with 30 fps received from the transmitting side by using an interpolated frame generating process.

In the example of FIG. 5, the image generating device 18 generates an R mesh 43ₜ₊₁ at time point t+1 from the R mesh 43t at time point t and the R mesh 43ₜ₊₂ at time point t+2.

The key frame flags of the R mesh 43ₜ at time point t and the R mesh 43ₜ₊₂ at time point t+2 are both “0” and indicate that the 3D shape has not significantly changed between successive frames.

In this case, as described with reference to FIG. 4, from coordinates of the corresponding respective vertices of the R mesh 43ₜ at time point t and the R mesh 43ₜ₊₂ at time point t+2, the image generating device 18 calculates respective coordinates of the vertices at time point t+1 to generate the R mesh 43ₜ₊₁ at time point t+1. Note that it is assumed that color information corresponding to the R mesh 43ₜ₊₁ at time point t+1 is not particularly limited in the present technology, and is generated by any method using the color information of the R mesh 43ₜ at time point t and the R mesh 43ₜ₊₂ at time point t+2.

FIG. 6 is a diagram illustrating an interpolated frame generating process in a case where the key frame flag is “1”, that is, in a case where the 3D shape has greatly changed between successive frames.

In FIG. 6, out of the R mesh 43ₜ at time point t and the R mesh 43ₜ₊₂ at time point t+2 supplied from the transmitting side, the key frame flag of the R mesh 43ₜ₊₂ at time point t+2 is “1”, which indicates that the 3D shape has greatly changed between the R mesh 43ₜ at time point t and the R mesh 43ₜ₊₂ at time point t+2.

In a case where the 3D shape has greatly changed between the frames at time t and time t+2, the R mesh 43ₜ₊₂ at time point t+2 does not correspond to the R mesh 43ₜ at time point t immediately before time point t+2. Therefore, the interpolation process using the R mesh 43ₜ at time point t and the R mesh 43ₜ₊₂ at time point t+2 as described with reference to FIG. 4 cannot be performed. In other words, the case where the 3D shape has greatly changed falls under, for example, a case where the difference between the number of vertices of the U meshes 42 at successive frames at time points t and the time t+2 is equal to or more than a predetermined number, a case where it is not possible to determine vertices corresponding to those of the immediately preceding frame in the mesh tracking process, or the like.

Therefore, as illustrated in FIG. 6, the image generating device 18 copies the R mesh 43t at time point t to generate the R mesh 43ₜ₊₁ at time point t+1. Alternatively, the image generating device 18 copies the R mesh 43ₜ₊₂ at time point t+2 to generate the R mesh 43ₜ₊₁ at time point t+1. In this case, since the R mesh 42ₜ₊₂ at time point t+2 is a copy of the U mesh 42ₜ₊₂ at time point t+2 as it is, substantially, the U mesh 42ₜ₊₂ at time point t+2 is copied to generate the R mesh at time point t+1.

As described above, the image generating device 18 changes the interpolated frame generating method on the basis of the key frame flag.

The image processing system 1 in FIG. 1 is configured as described above. Hereinafter, details of processes performed by the respective devices will be described.

<2. Key Frame Flag Generating Process>

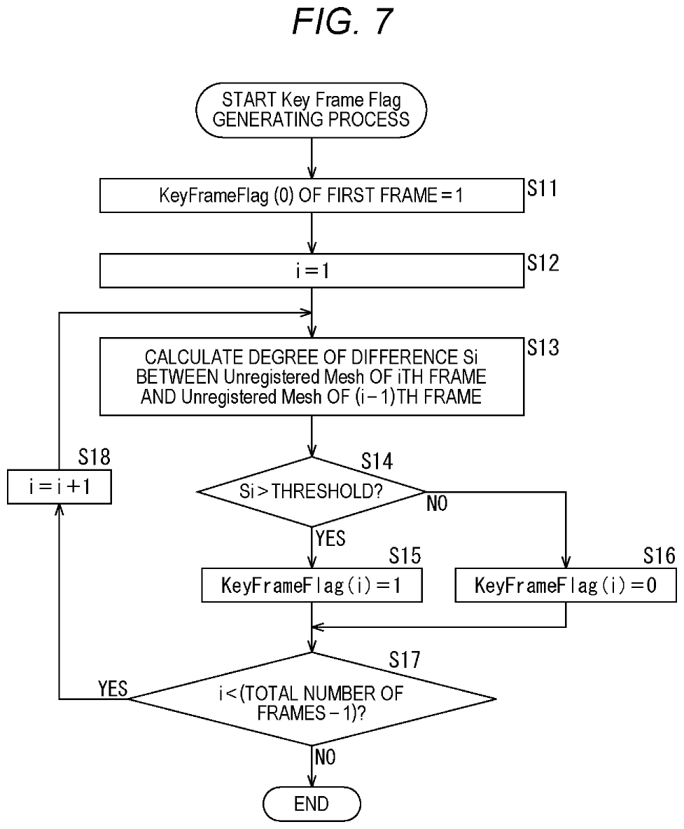

First, the key frame flag generating process executed by the flag generating device 12 will be described with reference to the flowchart in FIG. 7.

First, in step S11, the flag generating device 12 sets the key frame flag of the first frame of 3D data supplied from the 3D modeling device 11 to “1” (KeyFrameFlag (0)=1).

In step S12, the flag generating device 12 sets a variable i indicating the frame number of the 3D data to 1. Note that the first frame for which the key frame flag “1” is set in step S11 corresponds to the frame number “0”.

In step S13, the flag generating device 12 calculates the degree of difference Si between the U mesh of the ith frame and the U mesh of the (i−1)th frame.

In step S14, the flag generating device 12 judges whether the calculated degree of difference Si of the ith frame is greater than a predetermined threshold.

In a case where it is judged in step S14 that the degree of difference Si of the ith frame is greater than the predetermined threshold, the process proceeds to step S15, and the flag generating device 12 sets KeyFrameFlag (i)=1, that is, sets the key frame flag of the ith frame to “1”, and the process proceeds to step S17.

In contrast, in a case where it is judged in step S14 that the degree of difference Si of the ith frame is equal to or smaller than the predetermined threshold, the process proceeds to step S16, and the flag generating device 12 sets KeyFrameFlag (i)=0, that is, sets the key frame flag of the ith frame to “0”, and the process proceeds to step S17.

In step S17, the flag generating device 12 judges whether the variable i indicating the frame number is smaller than (the total number of frames−1) of the 3D data supplied from the 3D modeling device 11.

In a case where it is judged in step S17 that the variable i indicating the frame number is smaller than (the total number of frames−1) of the 3D data, that is, in a case where it is judged that the key frame flags have not been set for all the pieces of the 3D data, the process proceeds to step S18.

Then, in step S18, after the variable i indicating the frame number is incremented by 1, the process returns to step S13, and the above-described steps S13 to S17 are executed again. Therefore, the key frame flag of the next frame is set.

In contrast, in a case where it is judged in step S17 that the variable i indicating the frame number is equal to or more than (the total number of frames−1) of the 3D data, that is, in a case where it is judged that the key frame flags are set for all the pieces of the 3D data, the key frame flag generating process ends.

<3. Key Frame Flag Storing Process>

Next, a key frame flag storing process executed by the transmitting device 15 will be described.

As described above, the transmitting device 15 causes the compressed mesh data supplied from the coding device 14 and the key frame flag of each frame supplied from the flag generating device 12 to be stored in one bit stream, and transmits the bit stream to the receiving device 16 via the network.

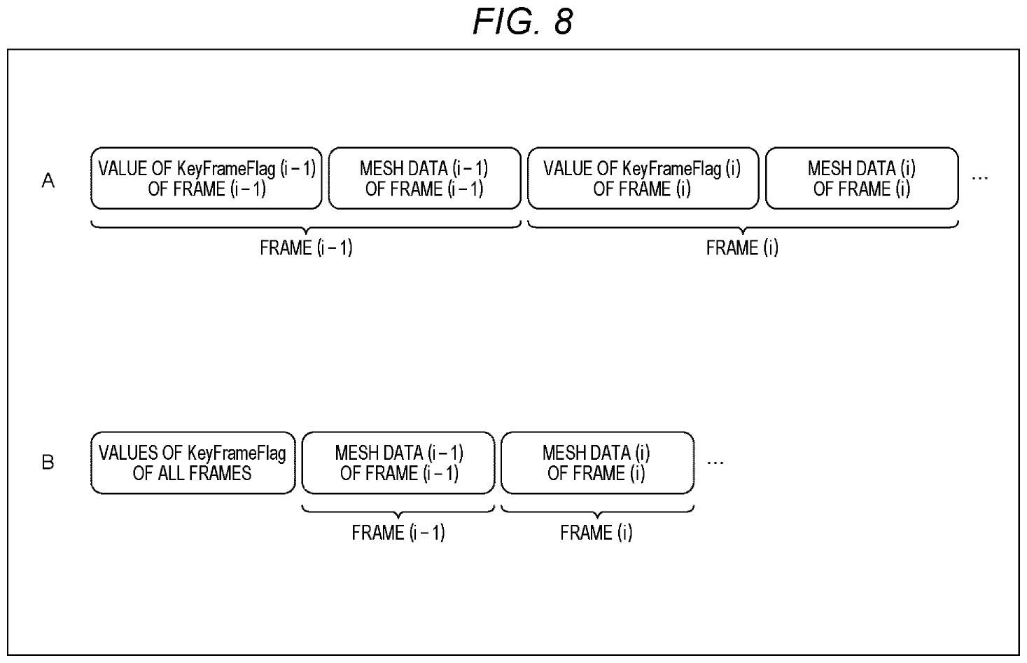

Here, the method of storing the key frame flag of each frame in the bit stream can be one of the two types of storing methods illustrated in FIG. 8.

One of the storing methods is a method of storing a key frame flag for each frame as illustrated in A of FIG. 8. For example, a key frame flag is stored as metadata of mesh data of each frame.

The other storing method is a method of storing the key frame flags of all the frames collectively as illustrated in B of FIG. 8. For example, as metadata of a bit stream, the key frame flags of all the frames are stored.

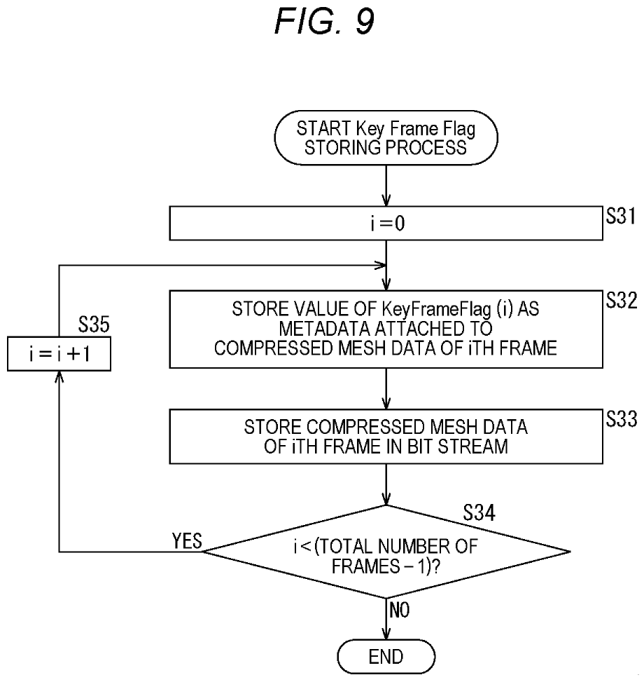

With reference to the flowchart in FIG. 9, a description will be given of a key frame flag storing process in a case where a key frame flag is stored in a bit stream for each frame as illustrated in A of FIG. 8.

First, in step S31, the transmitting device 15 sets the variable i indicating a frame number of 3D data to 0.

In step S32, the transmitting device 15 causes the key frame flag of the ith frame supplied from the flag generating device 12 (the value of KeyFrameFlag (i)) to be stored in a bit stream, as metadata attached to compressed mesh data of the ith frame.

In step S33, the transmitting device 15 causes the compressed mesh data of the ith frame supplied from the coding device 14 to be stored in a bit stream.

In step S34, the transmitting device 15 judges whether the variable i indicating the frame number is smaller than (the total number of frames−1) of the 3D data supplied from the coding device 14.

In a case where it is judged in step S34 that the variable i indicating the frame number is smaller than (the total number of frames−1) of the 3D data, that is, in a case where it is judged that the key frame flag has not been stored for all the frames of the 3D data to be transmitted, the process proceeds to step S35.

Then, in step S35, after the variable i indicating the frame number is incremented by 1, the process returns to step S32, and the above-described steps S32 to S34 are executed again. Therefore, the process of storing the key frame flag of the next frame is performed.

In contrast, in a case where it is judged in step S34 that the variable i indicating the frame number is equal to or more than (the total number of frames−1) of the 3D data, that is, in a case where it is judged that the key frame flags are stored for all the frames of the 3D data to be transmitted, the key frame flag storing process ends.

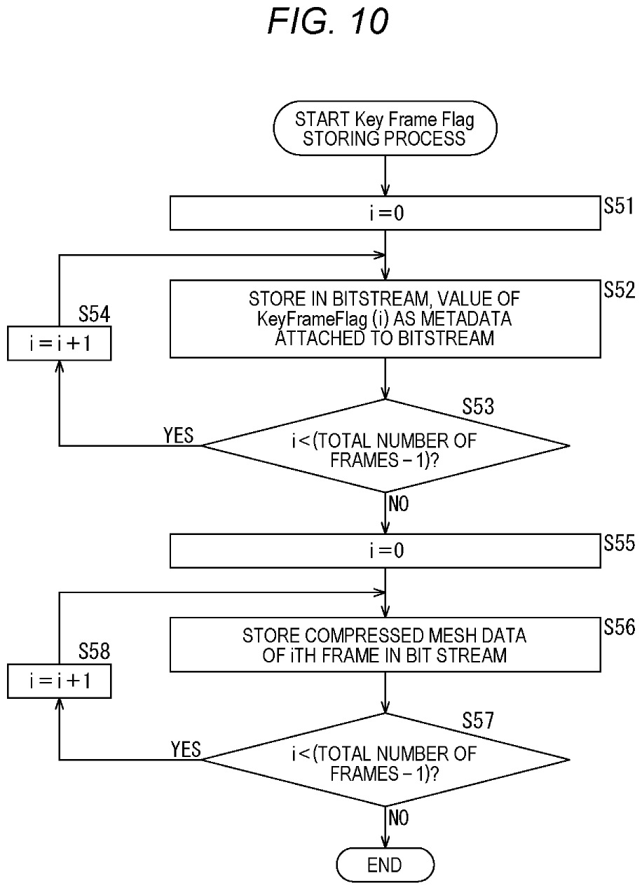

Next, with reference to the flowchart in FIG. 10, a description will be given of a key frame flag storing process in a case where key frame flags of all the frames are stored collectively in a bit stream as illustrated in B of FIG. 8.

First, in step S51, the transmitting device 15 sets the variable i indicating the frame number of 3D data to 0.

In step S52, the transmitting device 15 causes the key frame flag of the ith frame supplied from the flag generating device 12 (the value of KeyFrameFlag (i)) to be stored in a bit stream, as metadata attached to the bit stream.

In step S53, the transmitting device 15 judges whether the variable i indicating the frame number is smaller than (the total number of frames−1) of the 3D data supplied from the coding device 14.

In a case where it is judged in step S53 that the variable i indicating the frame number is smaller than (the total number of frames−1) of the 3D data, that is, in a case where it is judged that the key frame flag has not been stored for all the frames of the 3D data to be transmitted, the process proceeds to step S54.

Then, in step S54, after the variable i indicating the frame number is incremented by 1, the process returns to step S52, and the above-described steps S52 and S53 are executed again. Therefore, the process of storing the key frame flag of the next frame is performed.

In contrast, in a case where it is judged in step S53 that the variable i indicating the frame number is equal to or greater than (the total number of frames−1) of the 3D data, that is, in a case where it is judged that the key frame flag has been stored for all the frames of the 3D data to be transmitted, the process proceeds to step S55.

In step S55, the transmitting device 15 sets again the variable i indicating the frame number of 3D data to 0.

In step S56, the transmitting device 15 causes the compressed mesh data of the ith frame supplied from the coding device 14 to be stored in a bit stream.

In step S57, the transmitting device 15 judges whether the variable i indicating the frame number is smaller than (the total number of frames−1) of the 3D data supplied from the coding device 14.

In a case where it is judged in step S57 that the variable i indicating the frame number is smaller than (the total number of frames−1) of the 3D data, that is, in a case where it is judged that the compressed mesh data of all the frames of the 3D data to be transmitted is not yet stored, the process proceeds to step S58.

Then, in step S58, after the variable i indicating the frame number is incremented by 1, the process returns to step S56, and the above-described steps S56 and S57 are executed again. Therefore, the process of storing the compressed mesh data of the next frame is performed.

In contrast, in a case where it is judged in step S57 that the variable i indicating the frame number is equal to or more than (the total number of frames−1) of the 3D data, that is, in a case where it is judged that the compressed mesh data is stored for all the frames of 3D data to be transmitted, the key frame flag storing process ends.

<4. Key Frame Flag Separating Process>

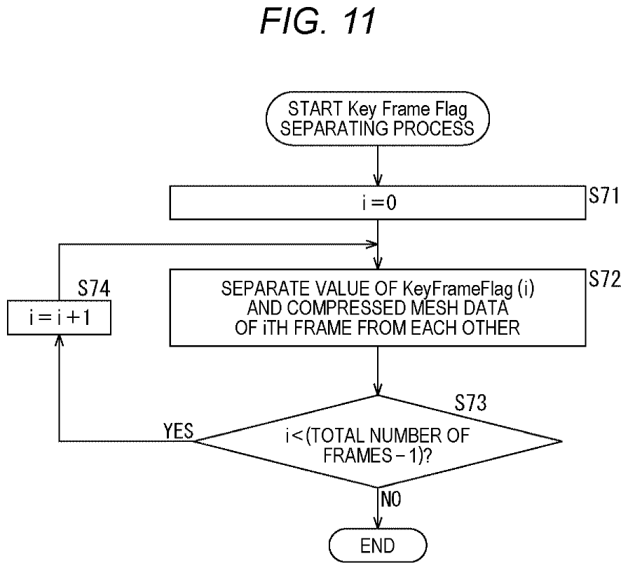

Next, with reference to the flowchart in FIG. 11, a description will be given of a key frame flag separating process of separating a bit stream in which a key frame flag is stored for each frame. This process is a process executed by the receiving device 16 in a case where the transmitting device 15 performs the key frame flag storing process of FIG. 9 and transmits the bit stream.

First, in step S71, the receiving device 16 sets the variable i indicating the frame number of 3D data to 0.

In step S72, the receiving device 16 separates and acquires the key frame flag (value of KeyFrameFlag (i)) of the ith frame and the compressed mesh data of the ith frame. Then, the receiving device 16 supplies the key frame flag of the ith frame to the image generating device 18, and supplies the compressed mesh data of the ith frame to the decoding device 17.

In step S73, the receiving device 16 judges whether the variable i indicating the frame number is smaller than (the total number of frames−1) of the 3D data. The total number of frames of 3D data can be acquired from, for example, metadata of the bit stream.

In a case where it is judged in step S73 that the variable i indicating the frame number is smaller than (the total number of frames−1) of the 3D data, that is, in a case where it is judged that the key frame flag and compressed metadata are separated from each other in all the frames of the received 3D data, the process proceeds to step S74.

Then, in step S74, after the variable i indicating the frame number is incremented by 1, the process returns to step S72, and the above-described step S72 is executed again. Therefore, the process of separating the key frame flag and compressed metadata of the next frame from each other is performed.

In contrast, in a case where it is judged in step S73 that the variable i indicating the frame number is equal to or more than (the total number of frames−1) of the 3D data, that is, in a case where it is judged that the key frame flags and compressed metadata are separated from each other for all the frames of the received 3D data, the key frame flag separating process ends.

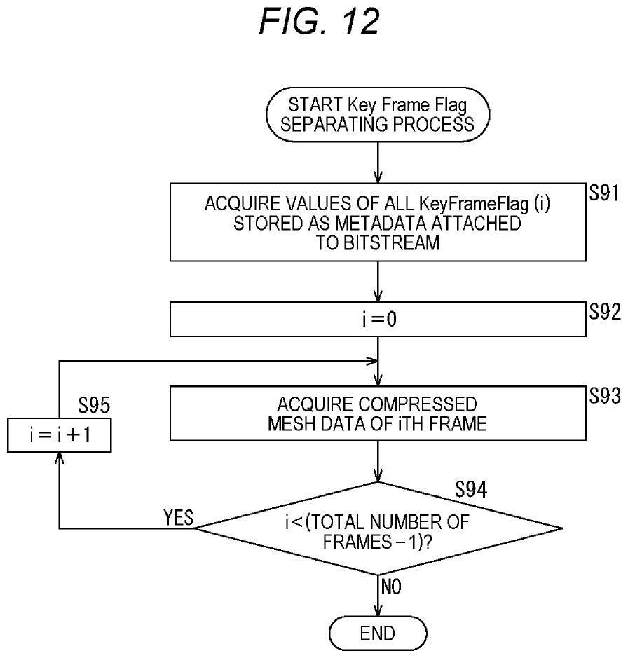

Next, with reference to the flowchart in FIG. 12, a description will be given of a key frame flag separating process of separating a bit stream in which the key frame flags of all the frames are stored collectively. This process is a process executed by the receiving device 16 in a case where the transmitting device 15 performs the key frame flag storing process of FIG. 10 and transmits the bit stream.

First, in step S91, the receiving device 16 acquires the key frame flags (values of KeyFrameFlag (i)) of all the frames stored as metadata attached to the bit stream, and supplies the key frame flags to the image generating device 18.

In step S92, the receiving device 16 sets the variable i indicating the frame number of 3D data to 0.

In step S93, the receiving device 16 acquires compressed mesh data of the ith frame and supplies the compressed mesh data to the decoding device 17.

In step S94, the receiving device 16 judges whether the variable i indicating the frame number is smaller than (the total number of frames−1) of the 3D data. The total number of frames of 3D data can be acquired from, for example, metadata of the bit stream.

In a case where it is judged in step S94 that the variable i indicating the frame number is smaller than (the total number of frames−1) of the 3D data, that is, in a case where it is judged that the compressed metadata of all the frames of the received 3D data is not yet acquired, the process proceeds to step S95.

Then, in step S95, after the variable i indicating the frame number is incremented by 1, the process returns to step S93, and the above-described step S93 is executed again. Therefore, the process of acquiring compressed mesh data of the next frame is performed.

In contrast, in a case where it is judged in step S94 that the variable i indicating the frame number is equal to or more than (the total number of frames−1) of the 3D data, that is, in a case where it is judged that compressed metadata of all the frames of the received 3D data is acquired, the key frame flag separating process ends.

<5. Interpolated Frame Generating Process>

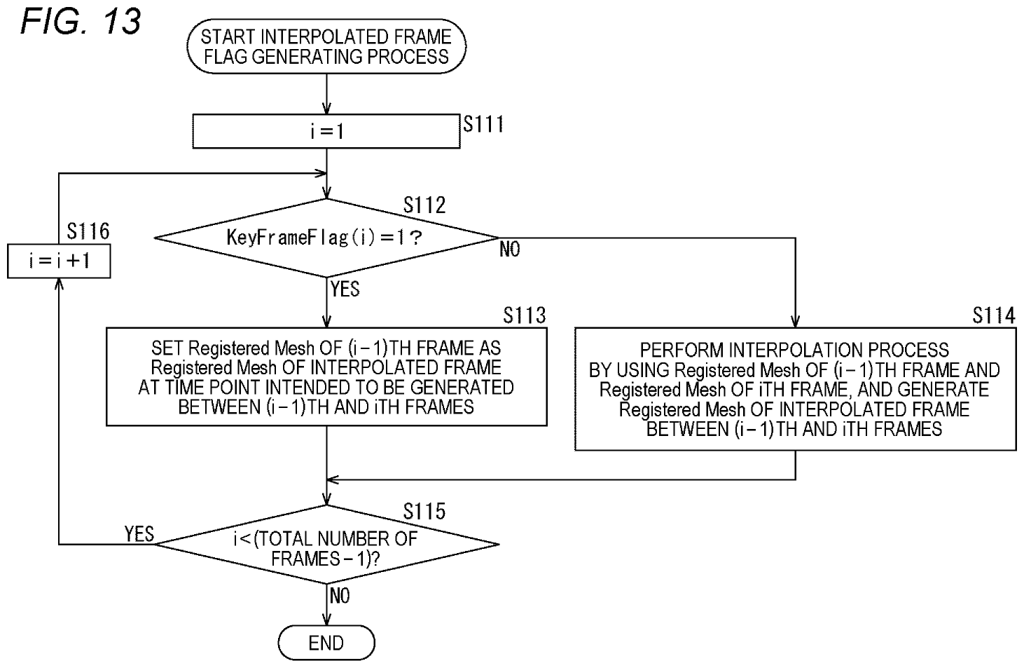

Next, an interpolated frame generating process in which the image generating device 18 generates an interpolated frame between received respective frames by using the R meshes and the key frame flags of the respective frames will be described with reference to the flowchart of FIG. 13.

Note that before the interpolated frame generating process of FIG. 13 is executed, the compressed mesh data of each frame supplied to the decoding device 17 by the key frame flag separating process of FIG. 11 or 12 is decoded by the decoding device 17, and is supplied to the image generating device 18.

First, in step S111, the image generating device 18 sets the variable i indicating the frame number of 3D data to 1.

In step S112, the image generating device 18 judges whether the key frame flag of the ith frame (value of KeyFrameFlag (i)) is “1”.

In step S112, in a case where the key frame flag of the ith frame is “1”, that is, the R mesh of the ith frame has significantly changed as compared with the R mesh of the (i−1)th frame, the process proceeds to step S113.

In step S113, the image generating device 18 sets the R mesh of the (i−1)th frame as the R mesh of the interpolated frame at the time point intended to be generated between the (i−1)th and the ith frames. In other words, the image generating device 18 copies the R mesh of the (i−1)th frame and generates the R mesh of the interpolated frame between the (i−1)th and ith frames.

Note that instead of using the R-mesh of the (i−1)th frame, the R-mesh (U mesh) of the ith frame may be used as the R mesh of the frame at the time point intended to be generated.

In contrast, in step S112, in a case where the key frame flag of the ith frame is not “1” (is “0”), that is, the R mesh of the ith frame has not greatly changed from the R mesh of the (i−1)th frame, the process proceeds to step S114.

In step S114, the image generating device 18 performs an interpolation process by using the R mesh of the (i−1)th frame and the R mesh of the ith frame, and generates the R mesh of the interpolated frame between the (i−1)th and the ith frames.

In step S115, the image generating device 18 judges whether the variable i indicating the frame number is smaller than (the total number of frames−1) of the 3D data.

In a case where it is judged in step S115 that the variable i indicating the frame number is smaller than (the total number of frames−1) of the 3D data, that is, in a case where it is judged that the interpolated frames between all the frames of the 3D data have not been generated, the process proceeds to step S116.

Then, in step S116, after the variable i indicating the frame number is incremented by 1, the process returns to step S112, and the above-described steps S112 to S115 are executed again. Therefore, the R mesh of the interpolated frame with the next frame is generated.

In contrast, in a case where it is judged in step S115 that the variable i indicating the frame number is equal to or more than (the total number of frames−1) of the 3D data, that is, in a case where it is judged that interpolated frames between all the frames of the 3D data are generated, the interpolated frame generating process ends.

<6. Interpolation Process>

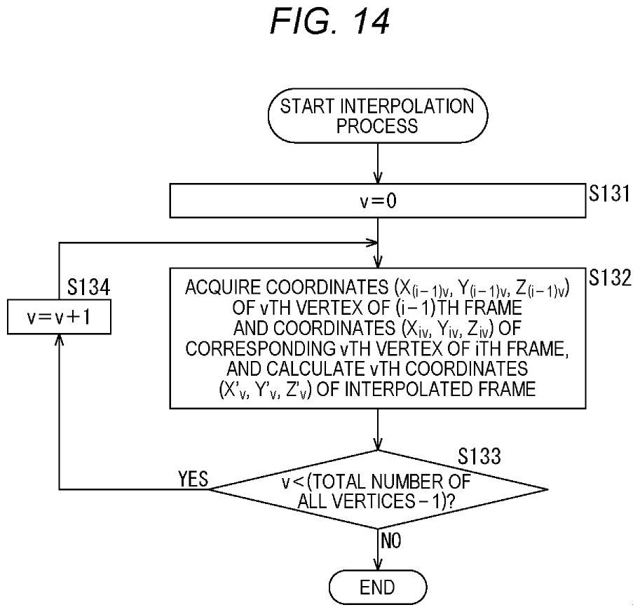

The interpolation process executed in step S114 in FIG. 13 will be described with reference to the flowchart in FIG. 14.

First, in step S131, the image generating device 18 sets the variable v indicating a vertex number of an interpolated frame to be generated to 0.

In step S132, the image generating device 18 acquires coordinates (x₍ᵢ₋₁₎ᵥ, y₍ᵢ₋₁₎ᵥ, z₍ᵢ₋₁₎ᵥ) of the vth vertex of the (i−1)th frame and the coordinates (xᵢᵥ, yᵢᵥ, zᵢᵥ) of the corresponding vth vertex of the ith frame, and calculates the coordinates (x′ᵥ, y′ᵥ, z′ᵥ) of the vth vertex of the interpolated frame.

For example, the coordinates (x′ᵥ, y′ᵥ, z′ᵥ) of the vth vertex of the interpolated frame can be calculated as follows.

x′ᵥ=(x₍ᵢ₋₁₎ᵥ+xᵢᵥ)/2

y′ᵥ=(y₍ᵢ₋₁₎ᵥ+yᵢᵥ)/2

z′ᵥ=(z₍ᵢ₋₁₎ᵥ+zᵢᵥ)/2

Note that the above expressions are an example in which a frame at an intermediate time point between the (i−1)th frame and the ith frame is used as an interpolated frame; however, by using the following expressions, it is possible to set a frame at an any time point between the (i−1)th frame and the ith frame to an interpolated frame.

x′ᵥ=t*x₍ᵢ₋₁₎ᵥ+(1−t)*xᵢᵥ

y′ᵥ=t*y₍ᵢ₋₁₎ᵥ+(1−t)*yᵢᵥ

z′ᵥ=t*z₍ᵢ₋₁₎ᵥ+(1−t)*zᵢᵥ

t is a value of 0.0≤t≤1.0, and corresponds to the time point of the interpolated frame in a case where t=1 is the time point of the (i−1)th frame and t=0 is the time point of the ith frame.

In step S133, the image generating device 18 judges whether the variable v indicating the vertex number is smaller than (the total number of vertices−1) of the interpolated frame. The total number of vertices of the interpolated frame is set to be the same as the total number of vertices of each of the (i−1)th frame and the ith frame.

In a case where it is judged in step S133 that the variable v indicating the vertex number is smaller than (the total number of vertices−1) of the interpolated frame, the process proceeds to step S134.

Then, in step S134, after the variable v indicating the vertex number is incremented by 1, the process returns to step S132, and the above-described steps S132 and S133 are executed again. Therefore, the coordinates of the next vertex of the interpolated frame are calculated.

In contrast, in a case where it is judged in step S133 that the variable v indicating the vertex number is equal to or more than (the total number of vertices−1) of the interpolated frame, that is, the coordinates of all the vertices of the interpolated frame are calculated, the interpolation process ends.

<7. Transfer Data Transmitting Process>

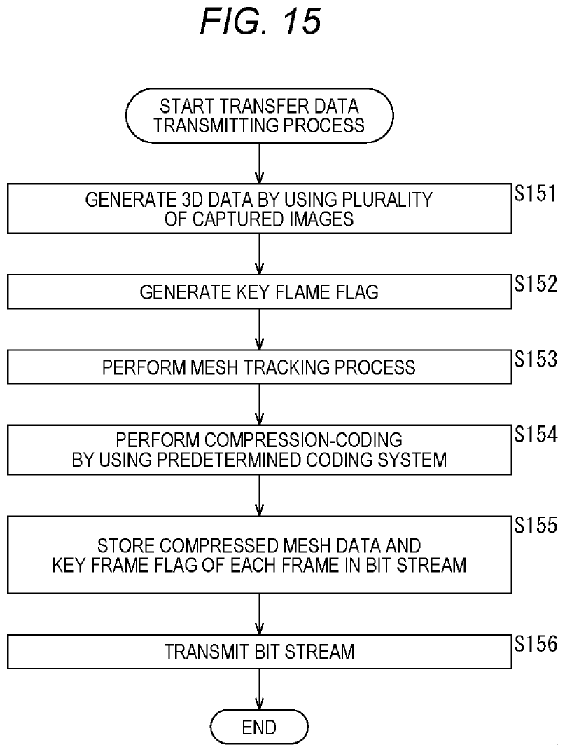

Next, a transfer data transmitting process, which is a process of the entire transmitting side, will be described with reference to the flowchart of FIG. 15. Note that it is assumed that before this process is started, captured images obtained by capturing a subject with the plurality of imaging devices 10A, respectively, are supplied to the 3D modeling device 11 and stored therein.

First, in step S151, the 3D modeling device 11 generates 3D data by using the plurality of captured images captured in synchronization by the plurality of imaging devices 10A. The generated 3D data is supplied to the flag generating device 12 and the tracking device 13. Here, in a case where each imaging device 10A includes a passive camera, captured images are only texture images. In a case where each imaging device 10A includes an active camera, captured images are texture images, IR images, and depth images. 3D data is expressed in a form having mesh data of polygon meshes and color information in association with each polygon mesh.

In step S152, the flag generating device 12 generates the key frame flag for each frame of the 3D data supplied from the 3D modeling device 11. More specifically, the flag generating device 12 calculates the degree of difference between the mesh data of two adjacent frames, sets the key frame flag to “1” in a case where the calculated degree of difference is greater than a predetermined threshold, and sets the key frame flag to “0” in a case where the calculated degree of difference is not greater than the predetermined threshold. The details of the process in step S152 are the key frame flag generating process described with reference to FIG. 7.

In step S153, the tracking device 13 executes a mesh tracking process, and generates an R mesh from the U mesh of each frame of the 3D data supplied from the 3D modeling device 11. The generated R mesh is supplied to the coding device 14.

In step S154, the coding device 14 compresses and codes the R mesh of each frame supplied from the tracking device 13 by using a predetermined coding system. The compressed mesh data obtained by compression coding is supplied to the transmitting device 15.

In step S155, the transmitting device 15 causes the compressed mesh data of each frame supplied from the coding device 14 and the key frame flag of each frame supplied from the flag generating device 12 to be stored in a bit stream. The details of the process in step S155 are the key frame flag storing process described with reference to FIGS. 9 and 10.

In step S156, the transmitting device 15 transmits the generated bit stream to the receiving device 16 via the network.

Thus, the transfer data transmitting process ends.

<8. Transfer Data Receiving Process>

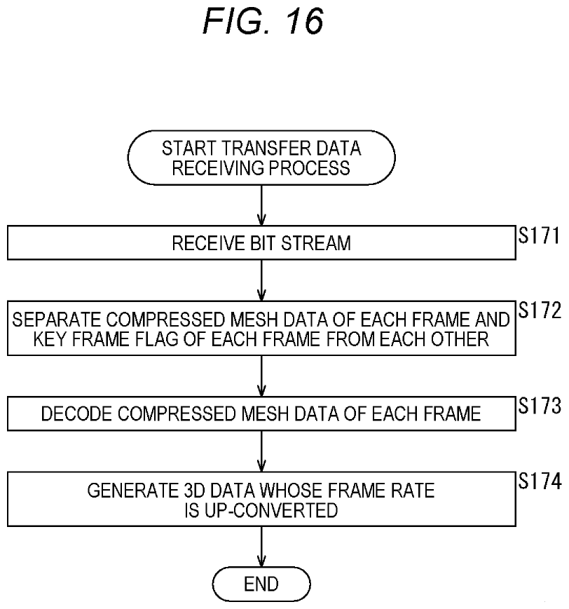

Next, a transfer data receiving process, which is a process of the entire receiving side, will be described with reference to the flowchart of FIG. 16. This process is started, for example, when a bit stream is transmitted to the receiving device 16 from the transmitting device 15.

First, in step S171, the receiving device 16 receives the bit stream of 3D data transmitted from the transmitting device 15 via the network.

In step S172, the receiving device 16 separates the compressed mesh data of each frame stored in the received bit stream of the 3D data from the key frame flag of each frame. The receiving device 16 supplies the compressed mesh data of each frame to the decoding device 17, and supplies the key frame flag of each frame to the image generating device 18. The details of the process in step S172 are the key frame flag separating process described with reference to FIGS. 11 and 12.

In step S173, the decoding device 17 decodes the compressed mesh data of each frame supplied from the receiving device 16 by a method corresponding to the coding system in the coding device 14. The decoding device 17 supplies the R mesh of each frame obtained by decoding to the image generating device 18.

In step S174, the image generating device 18 uses the R mesh of each frame supplied from the decoding device 17 and the key frame flag of each frame supplied from the decoding device 17 to execute an interpolated frame generating process, and generates 3D data whose frame rate is up-converted. Details of the processes in step S174 are the interpolated frame generating process in FIG. 13.

Thus, the transfer data receiving process ends.

According to the transfer data transmitting process and the transfer data receiving process executed in the image processing system 1, the transmitting side generates and transmits a key frame flag, and the reception side executes an interpolated frame generating process of interpolating the received respective frames on the basis of the key frame flag. Thus, 3D data with a higher frame rate can be generated.

On the transmitting side, there is no need to perform frame interpolation and it is only necessary to transmit 3D data at a lower frame rate. Therefore, the data amount upon transfer can be reduced.

On the receiving side, 3D data with a lower frame rate and the key frame flag of each frame are received. Thus, 3D data with a higher frame rate can be generated.

Since the 3D data transferred in the image processing system 1 is mesh data of a 3D shape, the 3D data is robust to changes in the 3D shape.

Note that in the above-described embodiment, the Hausdorff distance is calculated as the degree of difference between two frames, and the value of the key frame flag is determined as information based on the degree of difference between the two frames, on the basis of the calculated Hausdorff distance.

However, for example, the calculated value of the Hausdorff distance may be transmitted as it is as information based on the degree of difference between two frames.

<9. Example Using Interpolation Type>

Alternatively, other information may be transferred from the transmitting side to the receiving side as information based on the degree of difference between two frames.

For example, the transmitting side may transmit an interpolation type (Interpolation Type) for specifying an interpolation method for generating an interpolated frame, instead of transmitting a key frame flag, as information based on the degree of difference between two frames. Specifically, in a case where the flag generating device 12 causes the image generating device 18 to execute an interpolation process, the interpolation type “0” is transmitted. In a case where a frame after the interpolated frame is used, the interpolation type “1” is transmitted. In a case where the frame before the interpolated frame is used, the interpolation type “2” is transmitted. The interpolation type is determined on the basis of the key frame flag.

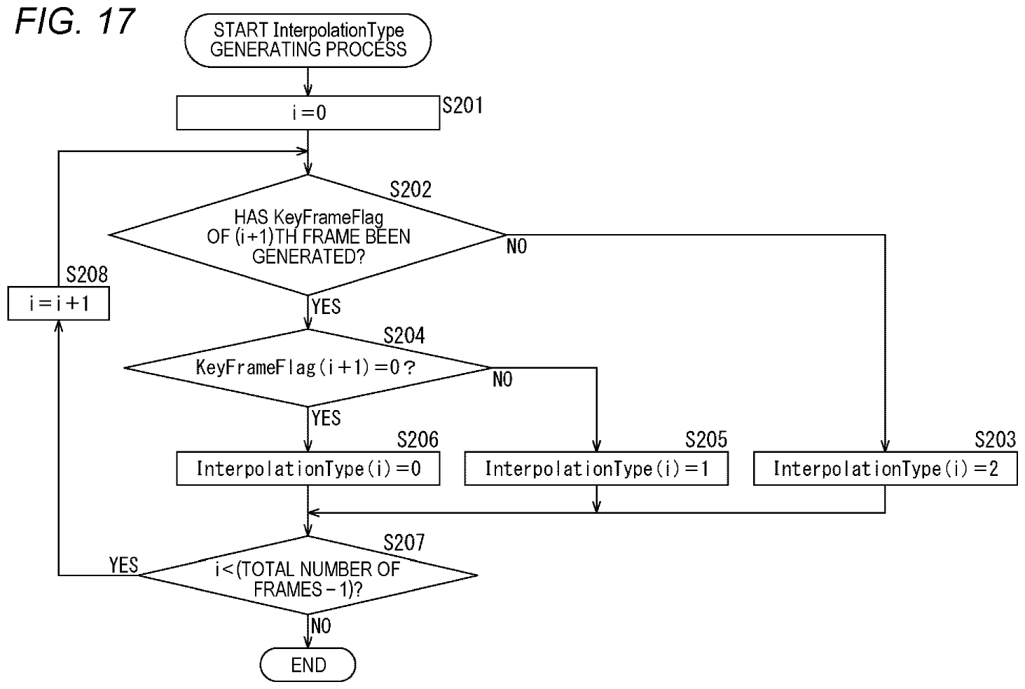

The interpolation type generating process executed by the flag generating device 12 will be described with reference to the flowchart in FIG. 17. Note that it is assumed that this process is performed after the key frame flag generating process of FIG. 7, and the key frame flag of each frame is known.

First, in step S201, the flag generating device 12 sets the variable i indicating the frame number of 3D data to 0.

In step S202, the flag generating device 12 judges whether the key frame flag of the (i+1)th frame has been generated.

In a case where it is judged in step S202 that the key frame flag of the (i+1)th frame is not generated, the process proceeds to step S203, and the flag generating device 12 sets the interpolation type of the ith frame to “2” (Interpolation Type (i)=2), and the process proceeds to step S207.

In contrast, in a case where it is judged in step S202 that the key frame flag of the (i+1)th frame has been generated, the process proceeds to step S204, and the flag generating device 12 judges whether the key frame flag of the (i+1)th frame is “0”.

In step S204, in a case where the key frame flag of the (i+1)th frame is not “0”, that is, the key frame flag of the (i+1)th frame is “1”, the process proceeds to step S205.

In step S205, the flag generating device 12 sets the interpolation type of the ith frame to “1” (Interpolation Type (i)=1), and the process proceeds to step S207.

In contrast, in a case where it is judged in step S204 that the key frame flag of the (i+1)th frame is “0”, the process proceeds to step S206, and the flag generating device 12 sets the interpolation type of the ith frame to “0” (Interpolation Type (i)=0), and the process proceeds to step S207.

In step S207, the flag generating device 12 judges whether the variable i indicating the frame number is smaller than (the total number of frames−1) of the 3D data.

In a case where it is determined in step S207 that the variable i indicating the frame number is smaller than (the total number of frames−1) of the 3D data, that is, in a case where it is determined that the interpolation types of all the frames of the 3D data have not been determined, the process proceeds to step S208.

Then, in step S208, after the variable i indicating the frame number is incremented by 1, the process returns to step S202, and the above-described steps S202 to S207 are executed again. Therefore, the interpolation type of the next frame is determined.

In contrast, in a case where it is judged in step S207 that the variable i indicating the frame number is equal to or more than (the total number of frames−1) of the 3D data, that is, interpolated types of all the frames of the 3D data are determined, the interpolation type generating process ends.

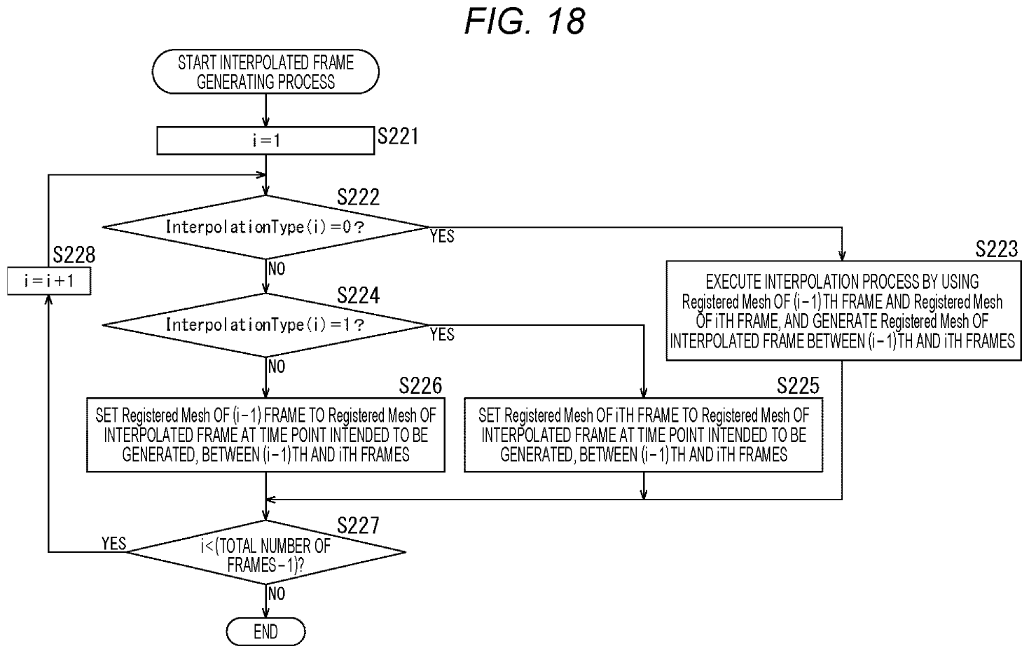

Next, an interpolated frame generating process executed in a case where an interpolation type is stored in a bit stream and transferred instead of a key frame flag will be described with reference to the flowchart of FIG. 18. This process is executed by the image generating device 18 instead of the interpolated frame generating process of FIG. 13.

First, in step S221, the image generating device 18 sets the variable i indicating the frame number of 3D data to 1.

In step S222, the image generating device 18 judges whether the interpolation type (the value of Interpolation Type (i)) of the ith frame is “0”.

In a case where it is judged in step S222 that the interpolation type of the ith frame is “0”, the process proceeds to step S223.

In step S223, the image generating device 18 executes an interpolation process by using the R mesh of the (i−1)th frame and the R mesh of the ith frame, generates the R mesh of the interpolated frame between the (i−1)th and the ith frames, and the process proceeds to step S227.

In contrast, in a case where it is judged in step S222 that the interpolation type of the ith frame is not “0”, the process proceeds to step S224.

In step S224, the image generating device 18 determines whether the interpolation type of the ith frame (the value of Interpolation Type (i)) is “1”.

In a case where it is judged in step S224 that the interpolation type of the ith frame is “1”, the process proceeds to step S225, the image generating device 18 copies the R mesh of the ith frame, generates the R mesh of the interpolated frame at a time point to be generated, between the (i−1)th and the ith frames, and the process proceeds to step S227.

In contrast, in a case where it is judged in step S224 that the interpolation type of the ith frame is not “1”, that is, is “2”, the process proceeds to step S226, the image generating device 18 copies the R mesh of the (i−1) frame and generates the R mesh of the interpolated frame at the time point intended to be generated, between the (i−1)th and the ith frames, and the process proceeds to step S227.

In step S227, the image generating device 18 judges whether the variable i indicating the frame number is smaller than (the total number of frames−1) of the 3D data.

In a case where it is judged in step S227 that the variable i indicating the frame number is smaller than (the total number of frames−1) of the 3D data, that is, in a case where it is judged that the interpolated frames between all the frames of the 3D data have not been generated, the process proceeds to step S228.

Then, in step S228, after the variable i indicating the frame number is incremented by 1, the process returns to step S222, and the above-described steps S222 to S227 are executed again. Therefore, the R mesh of the interpolated frame with the next frame is generated.

In contrast, in a case where it is judged in step S227 that the variable i indicating the frame number is equal to or more than (the total number of frames−1) of the 3D data, that is, in a case where it is judged that interpolated frames between all the frames of the 3D data are generated, the interpolated frame generating process ends.

As described above, even in a case where the transmitting side transmits the interpolation type instead of the key frame flag, the receiving side can generate an interpolated frame between the received frames on the basis of the interpolation type.

<10. Second Embodiment of Image Processing System>

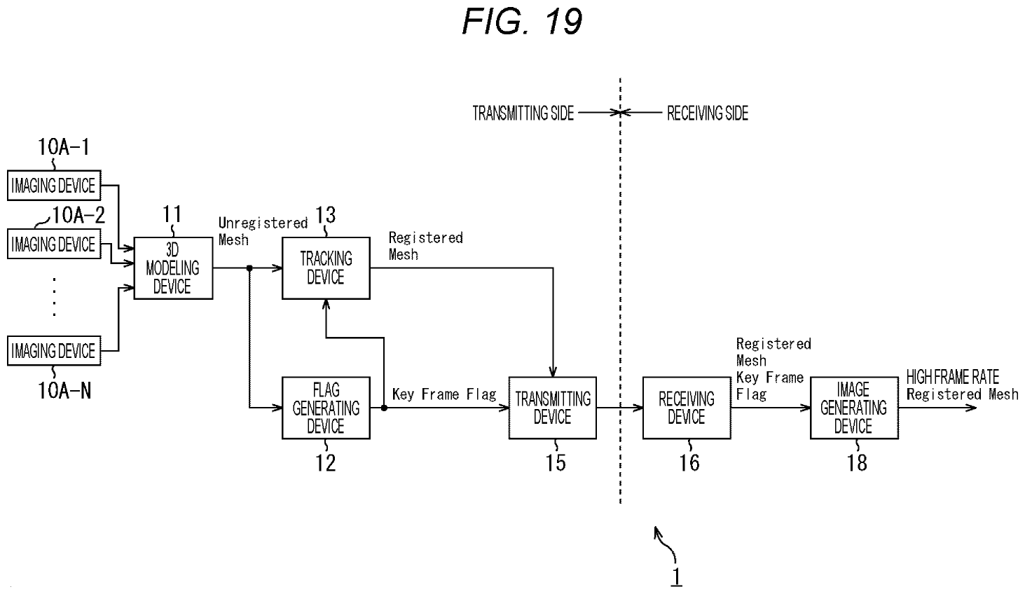

FIG. 19 is a block diagram illustrating a configuration example of a second embodiment of an image processing system to which the present technology is applied.

In FIG. 19, portions corresponding to those in the above-described first embodiment are denoted by the same reference signs, and description thereof will be omitted as appropriate.

As can be seen by comparing FIG. 1 and FIG. 19, in the second embodiment, a coding device 14 on the transmitting side and a decoding device 17 on the receiving side are omitted. In the first embodiment, the compressed mesh data of each frame is stored in a bit stream. However, the second embodiment is different in that the mesh data of each frame that is not compressed and coded is stored.

A tracking device 13 supplies a transmitting device 15 with an R mesh which is the mesh data subjected to a mesh tracking process. The transmitting device 15 causes the R mesh of each frame supplied from the tracking device 13 and the key frame flag of each frame supplied from the flag generating device 12 to be stored in one bit stream, and transmits the bit stream to a receiving device 16 via a network.

The receiving device 16 receives the bit stream of 3D data transmitted from the transmitting device 15 via the network. Then, the receiving device 16 separates the mesh data and the key frame flag of each frame stored in the received bit stream of the 3D data from each other, and supplies the mesh data and the key frame flag to an image generating device 18.

A transfer data transmitting process on the transmitting side in the second embodiment is a process in which step S154 is omitted from steps S151 to S156 in FIG. 15.

A transfer data receiving process on the receiving side in the second embodiment is a process in which step S173 is omitted from steps S171 to S174 in FIG. 16.

As described above, mesh data to be transferred may be compressed and coded by a predetermined coding system as in the first embodiment, or may not be compressed and coded as in the second embodiment.

<11. Third Embodiment of Image Processing System>

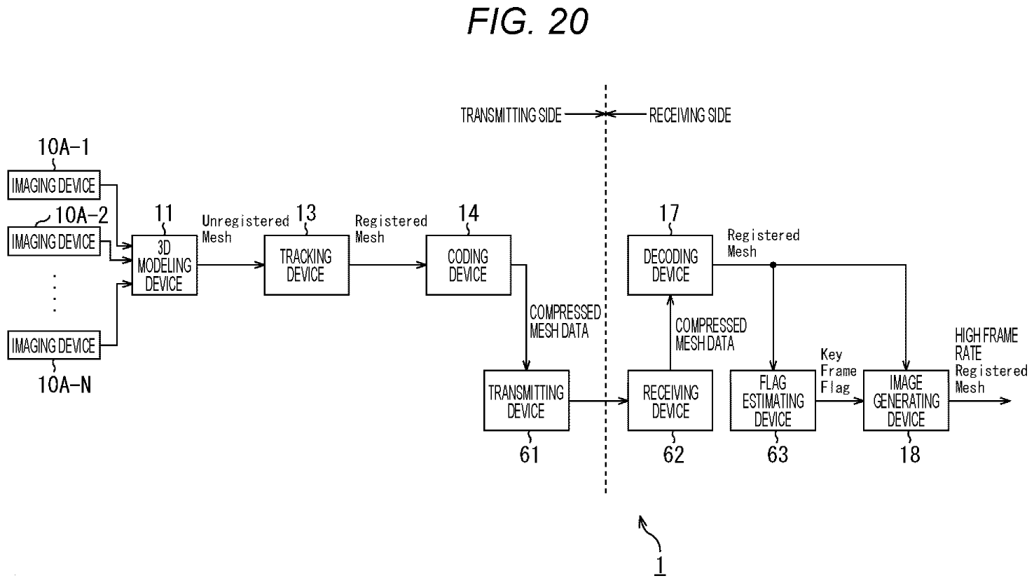

FIG. 20 is a block diagram illustrating a configuration example of a third embodiment of an image processing system to which the present technology is applied.

In FIG. 20, portions corresponding to those in the above-described first embodiment are denoted by the same reference signs, and description thereof will be omitted as appropriate.

As can be seen by comparing FIG. 1 and FIG. 20, in the third embodiment, a flag generating device 12 on the transmitting side is omitted and the transmitting device 15 is replaced with a transmitting device 61.

Furthermore, on the receiving side, the transmitting device 15 is replaced with a receiving device 62, and a flag estimating device 63 is newly added.

In the first embodiment, the key frame flag of each frame is generated by the flag generating device 12, is stored in a bit stream and is transmitted. However, in the third embodiment, the key frame flag of each frame is not generated, and is not transferred to the receiving side.

Therefore, what is different from FIG. 15 of the first embodiment is that the transmitting device 61 causes only the compressed mesh data of each frame to be stored in a bit stream and does not cause the key frame flag of each frame to be stored in the bit stream.

A transfer data transmitting process on the transmitting side in the third embodiment is the process from which the process related to the key frame flag of the transfer data transmission process of FIG. 15 is excluded.

The receiving device 62 receives the bit stream in which only the compressed mesh data of each frame is stored from the transmitting device 61, and supplies the bit stream to a decoding device 17. That is, the receiving device 62 is different from the receiving device 16 of the first embodiment in that the receiving device 62 does not perform a key frame flag separating process.

Since the key frame flag is not transferred from the transmitting side, the flag estimating device 63 estimates and generates a key frame flag on the basis of the frame type of each frame, and supplies the key frame flag to the image generating device 18. Specifically, among frame types of an Intra frame (hereinafter, referred to as an I frame), a Predictive frame (hereinafter, referred to as a P frame), and a Bidirectionally Predictive frame (hereinafter, referred to as a B frame), the flag estimating device 63 determines the key frame flag to be “1” for a frame whose frame type is the I frame, and determines the key frame flag to be “0” for a frame whose frame type is the P frame or the B frame and generates the key frame flags.

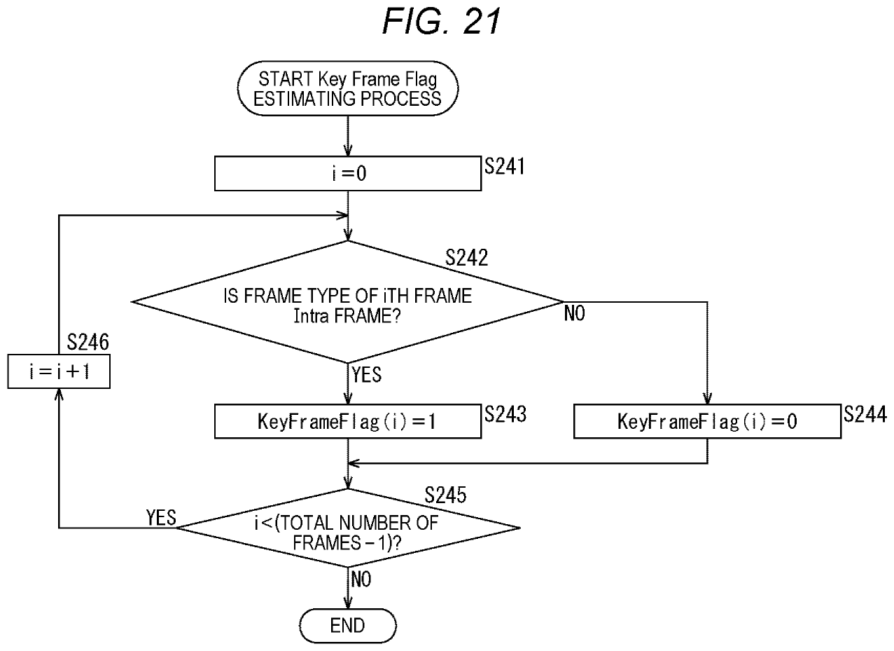

The key frame flag estimating process executed by the flag estimating device 63 will be described with reference to the flowchart in FIG. 21.

First, in step S241, the flag estimating device 63 sets the variable i indicating the frame number of 3D data to 0.

In step S242, the flag estimating device 63 judges whether the frame type of the ith frame is the I frame (Intra frame).

In a case where it is judged in step S242 that the frame type of the ith frame is the I frame, the process proceeds to step S243.

In step S243, the flag estimating device 63 determines the key frame flag of the ith frame to “1” and supplies the key frame flag to the image generating device 18.

In contrast, in a case where it is judged in step S242 that the frame type of the ith frame is not an I frame, that is, the frame type of the ith frame is either the P frame or the B frame, the process proceeds to step S244.

In step S244, the flag estimating device 63 determines the key frame flag of the ith frame to “0” and supplies the key frame flag to the image generating device 18.

In step S245, the flag estimating device 63 judges whether the variable i indicating the frame number is smaller than (the total number of frames−1) of the 3D data.

In a case where it is judged in step S245 that the variable i indicating the frame number is smaller than (the total number of frames−1) of the 3D data, that is, in a case where it is judged that the key frame flags of all the frames of the 3D data are not determined, the process proceeds to step S246.

Then, in step S246, after the variable i indicating the frame number is incremented by 1, the process returns to step S242, and the above-described steps S242 to S245 are executed again. Therefore, the key frame flag of the next frame is generated.

In contrast, in a case where it is judged in step S245 that the variable i indicating the frame number is equal to or more than (the total number of frames−1) of the 3D data, that is, in a case where it is judged that the key frame flags of all the frames of the 3D data are determined, the key frame flag estimating process ends.

The transfer data receiving process on the receiving side in the third embodiment is the process in which the process of separating the compressed mesh data and the key frame flag from each other in step S172 of the transfer data receiving process in FIG. 16 is replaced with the key frame flag estimating process described above and the estimated key frame flag is used instead of the received key frame flag.

<12. Fourth Embodiment of Image Processing System>

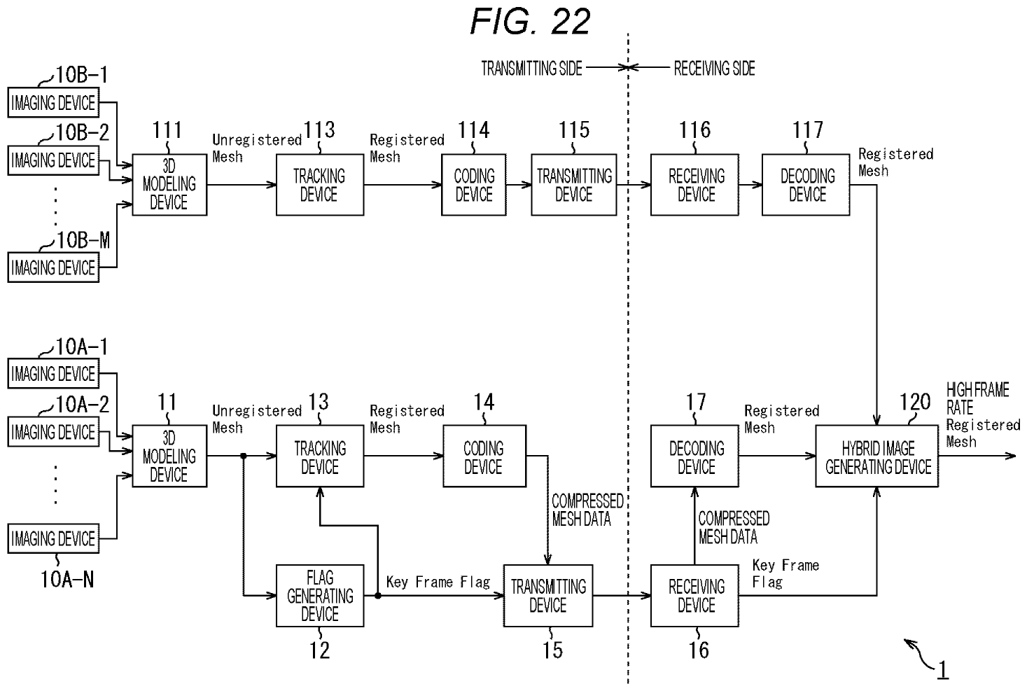

FIG. 22 is a block diagram illustrating a configuration example of a fourth embodiment of an image processing system to which the present technology is applied.

In FIG. 22, portions corresponding to those in the above-described first embodiment are denoted by the same reference signs, and description thereof will be omitted as appropriate.

In the fourth embodiment of FIG. 22, compared with the first embodiment of FIG. 1, on the transmitting side, a plurality of imaging devices 10B-1 to 10B-M (M>1), a 3D modeling device 111, a tracking device 113, a coding device 114, and a transmitting device 115 are newly provided. Furthermore, on the receiving side, a receiving device 116 and a decoding device 117 are newly provided. Moreover, the image generating device 18 is replaced with a hybrid image generating device 120.

In a case where it is not necessary to particularly distinguish a plurality of imaging devices 10B-1 to 10B-M from each other, each of the plurality of imaging devices 10B-1 to 10B-M is simply referred to as an imaging device 10B.

In the fourth embodiment, 3D data based on captured images obtained by the plurality of imaging devices 10A is transferred from the transmitting side to the receiving side, and 3D data based on the captured images obtained by the plurality of imaging devices 10B is also transferred from the transmitting side to the receiving side.

The plurality of imaging devices 10A and the plurality of imaging devices 10B are common in that the plurality of imaging devices 10A or the plurality of imaging devices 10B captures images of a subject in synchronization and supplies the captured images obtained as a result to the subsequent 3D modeling device 11 or a 3D modeling device 111. Each of the plurality of imaging devices 10A includes either a passive camera or an active camera, and each of the plurality of imaging devices 10B includes either a passive camera or an active camera.

In contrast, the plurality of imaging devices 10A and the plurality of imaging devices 10B are different in that frame rates when imaging a subject differ from each other. The frame rate of the captured images captured by the plurality of imaging devices 10B is higher than the frame rate of the captured images captured by the plurality of imaging devices 10A.

As described above, any of the imaging device 10A and the imaging devices 10B includes either a passive camera or an active camera. However, in general, the active camera has a lower frame rate. Therefore, in the present embodiment, a description will be given assuming that each of the plurality of imaging devices 10B is a passive camera that captures images at 60 fps, and each of the plurality of imaging devices 10A is an active camera that captures images at 30 fps.

Similarly to the 3D modeling device 11, the 3D modeling device 111 performs a 3D shape modeling process of the subject on the basis of the plurality of captured images captured and obtained by the respective plurality of imaging devices 10B, and supplies 3D data obtained as a result to the tracking device 113.

Note that in the following, in order to make the description easy to understand, 3D data based on captured images obtained by the plurality of imaging devices 10B is referred to as 3D data B, and 3D data based on the captured images obtained by the plurality of imaging devices 10A is referred to as 3D data A.

Similarly to the tracking device 13, the tracking device 113 executes a mesh tracking process on the mesh data (U mesh) of each frame supplied as 3D data B from the 3D modeling device 111, and supplies the mesh data (R mesh) subjected to the mesh tracking process to the coding device 114.

Similarly to the coding device 14, the coding device 114 compresses and codes the R mesh of each frame supplied from the tracking device 113 by a predetermined coding system, and supplies compressed mesh data of each frame obtained as a result to the transmitting device 115.

Similarly to the transmitting device 61 according to the third embodiment which does not transfer a key frame flag, the transmitting device 115 causes only compressed mesh data of each frame to be stored in a bit stream and transmits the bit stream to the receiving device 116.

Similarly to the receiving device 62 of the third embodiment that does not transfer a key frame flag, the receiving device 116 receives the bit stream and supplies the bit stream to the decoding device 117.

Similarly to the decoding device 17, the decoding device 117 decodes the compressed mesh data of each frame supplied from the receiving device 116 by using a system corresponding to the coding system in the coding device 114. The decoding device 117 supplies the R mesh of each frame obtained by decoding to the hybrid image generating device 120.

Note that, in the fourth embodiment, the tracking device 113 may be omitted. In this case, the U mesh of each frame output from the tracking device 113 is supplied to the coding device 114.

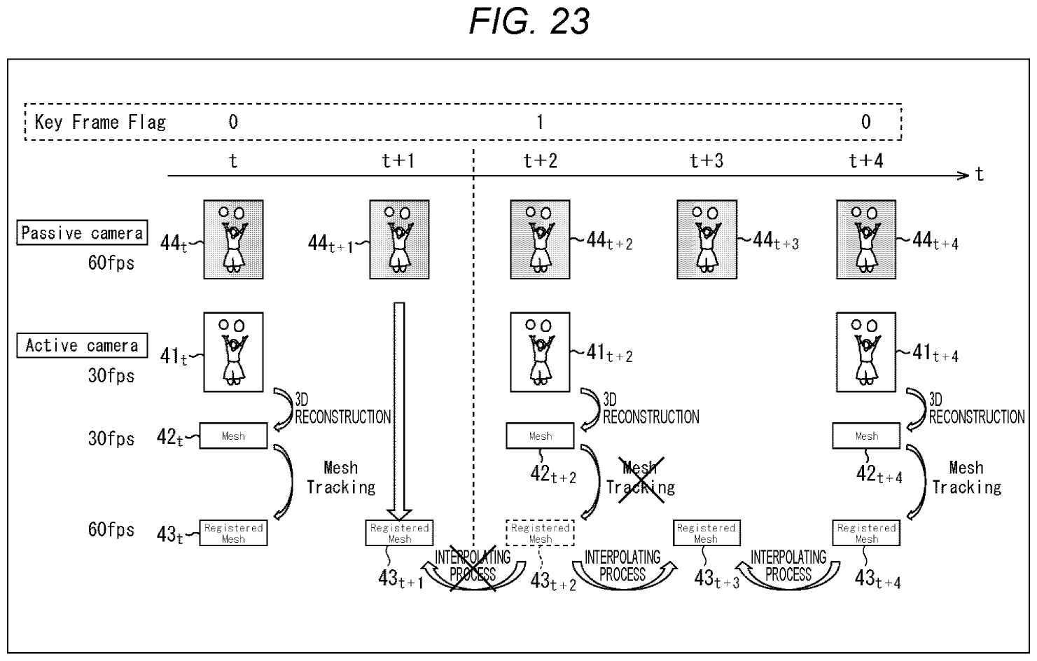

An interpolated frame generating process performed by the hybrid image generating device 120 will be described with reference to FIG. 23.

FIG. 23 is a diagram illustrating the interpolated frame generating process when the key frame flag at time point t+2 is “1” similarly to FIG. 6 in the first embodiment.

In FIG. 23, similarly to FIG. 6, a captured image 41t, a captured image 41ₜ+2, . . . with 30 fps obtained by the plurality of imaging devices 10A, and the U mesh 42ₜ, the U mesh 42ₜ₊₂, . . . with 30 fps generated by the 3D modeling device 11 are illustrated.

Moreover, a captured image 44ₜ, a captured image 44ₜ₊₁, a captured image 44ₜ₊₂, and . . . with 60 fps obtained by the plurality of imaging devices 10B are added.

In the first embodiment, when the key frame flag at time point t+2 is “1”, the R mesh at time point t is copied, or the R mesh 42ₜ₊₂ (U mesh 42ₜ₊₂) at time point t+2 is copied, and thus the R mesh 42ₜ₊₁ at time point t+1 is generated.

In contrast, in the fourth embodiment, the R mesh 42ₜ₊₁ at time point t+1 is generated by using the R mesh obtained from the captured image 44ₜ₊₁ with the higher frame rate.

The interpolated frame generating process in a case where the key frame flag is “0” is similar to that in the first embodiment. For example, similarly to the R mesh 43ₜ₊₃ at time point t+3, the R mesh 43ₜ₊₃ at time point t+3 is generated in the interpolation process between the R mesh 43ₜ₊₂ at time point t+2 and the R mesh 43ₜ₊₄ at time point t+4 before and the after time point t+3.

The process on the transmitting side for transmitting the 3D data B based on the plurality of captured images obtained by the plurality of imaging devices 10B is similar to the transfer data transmitting process of the third embodiment in which the key frame flag of each frame is not transferred.

The process on the receiving side of receiving 3D data B based on a plurality of captured images obtained by the plurality of imaging devices 10B is a process in which the key frame flag of each frame is not separated and steps S171 and S173 of the transfer data receiving process of FIG. 16 are performed.

<13. Hybrid Interpolated Frame Generating Process>

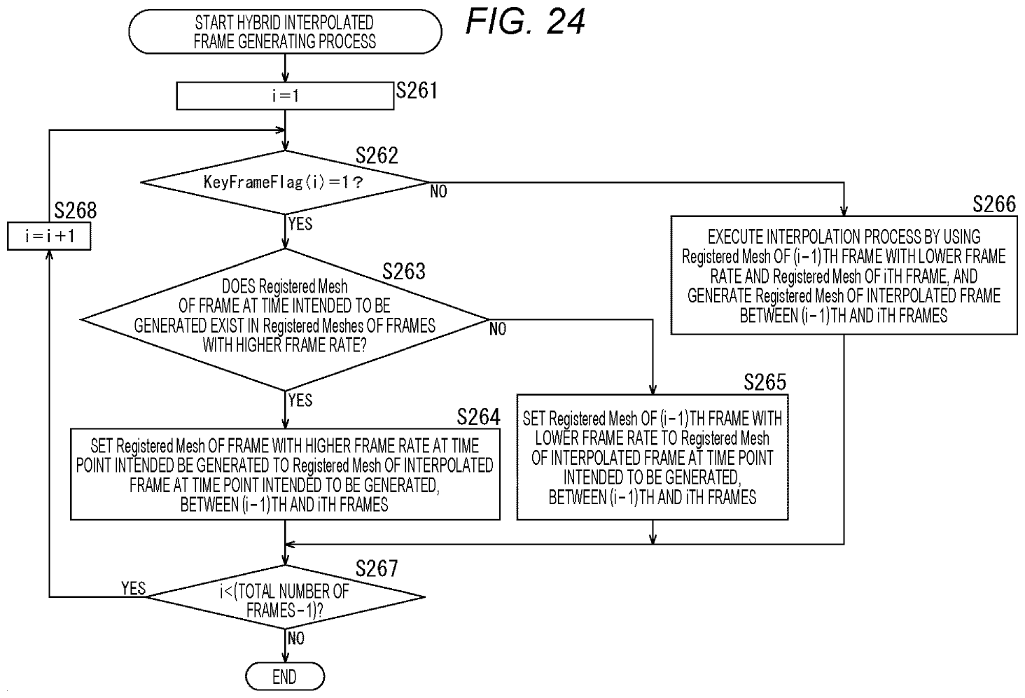

With reference to the flowchart of FIG. 24, a description will be given of a hybrid interpolated frame generating process of generating 3D data whose frame rate is up-converted by using two types of 3D data A and B having different frame rates.

Note that before the hybrid interpolated frame generating process of FIG. 24 is executed, to the hybrid image generating device 120, the R mesh of each frame with a low frame rate is supplied from the decoding device 17 and the R mesh of each frame with a high frame rate is supplied from the decoding device 117.

First, in step S261, the hybrid image generating device 120 sets the variable i indicating the frame number of 3D data A with the lower frame rate to 1.

In step S262, the hybrid image generating device 120 judges whether the key frame flag of the ith frame (the value of KeyFrameFlag (i)) is “1”.

In step S262, in a case where the key frame flag of the ith frame is “1”, that is, the R mesh of the ith frame has significantly changed as compared with the R mesh of the (i−1)th frame, the process proceeds to step S263.

In step S263, the hybrid image generating device 120 judges whether the R mesh of the frame at the time point intended to be generated exists in the R meshes of the frames of the 3D data B with the higher frame rate.

In a case where it is judged in step S263 that the R mesh of the frame at the time point intended to be generated exists, the process proceeds to step S264.

In step S264, the hybrid image generating device 120 uses the R mesh of the frame at the time point at which the 3D data B with the higher frame rate is intended to be generated, as the R mesh of the interpolated frame at the time point intended to be generated between the (i−1)th and the ith frames, and the process proceeds to step S267.

In contrast, in a case where it is judged in step S263 that the R mesh of the frame at the time point intended to be generated does not exist, the process proceeds to step S265.

In step S265, the hybrid image generating device 120 uses the R mesh of the (i−1)th frame of the lower frame rate as the R mesh of the interpolated frame at the time point intended to be generated between the (i−1)th and ith frames, and the process proceeds to step S267.

In contrast, in step S262, in a case where the key frame flag of the ith frame is not “1” (is “0”), that is, the R mesh of the ith frame has not greatly changed from the R mesh of the (i−1)th frame, the process proceeds to step S266.

In step S266, the hybrid image generating device 120 executes an interpolation process by using the R mesh of the (i−1)th frame with the lower frame rate and the R mesh of the ith frame, generates the R mesh of the interpolated frame between the (i−1)th and the ith frames, and the process proceeds to step S267.

In step S267, the hybrid image generating device 120 judges whether the variable i indicating the frame number is smaller than (the total number of frames−1) of the 3D data A with the lower frame rate.

In a case where it is judged in step S267 that the variable i indicating the frame number is smaller than (the total number of frames−1) of the 3D data A, that is, in a case where it is judged that not all the interpolated frames between all the frames of the 3D data A have been generated, the process proceeds to step S268.

Then, in step S268, after the variable i indicating the frame number is incremented by 1, the process returns to step S262, and the above-described steps S262 to S267 are executed again. Therefore, the R mesh of the interpolated frame with the next frame is generated.

In contrast, in a case where it is judged in step S267 that the variable i indicating the frame number is equal to or more than (the total number of frames−1) of the 3D data A, that is, in a case where it is judged that interpolated frames between all the frames of the 3D data A are generated, the hybrid interpolated frame generating process ends.

As described above, in the hybrid interpolated frame generating process, in a case where the key frame flag of a frame is “1”, that is, in a case where the change in the 3D shape of the subject from the previous frame is great, it is possible to generate the R mesh of the interpolated frame at the time point intended to be generated by using the mesh data with the higher frame rate.

Therefore, by transferring two types of 3D data A and B having with different frame rates from the transmitting side to the receiving side, even in a case where a change in the 3D shape of the subject is great, 3D data with a higher frame rate whose frame rate is up-converted can be generated.

<14. Example Using Interpolation Type>

Also in the fourth embodiment using two types of imaging devices 10A and 10B with different frame rates, the transmitting side may transmit an interpolation type designating an interpolation method instead of transmitting a key frame flag.

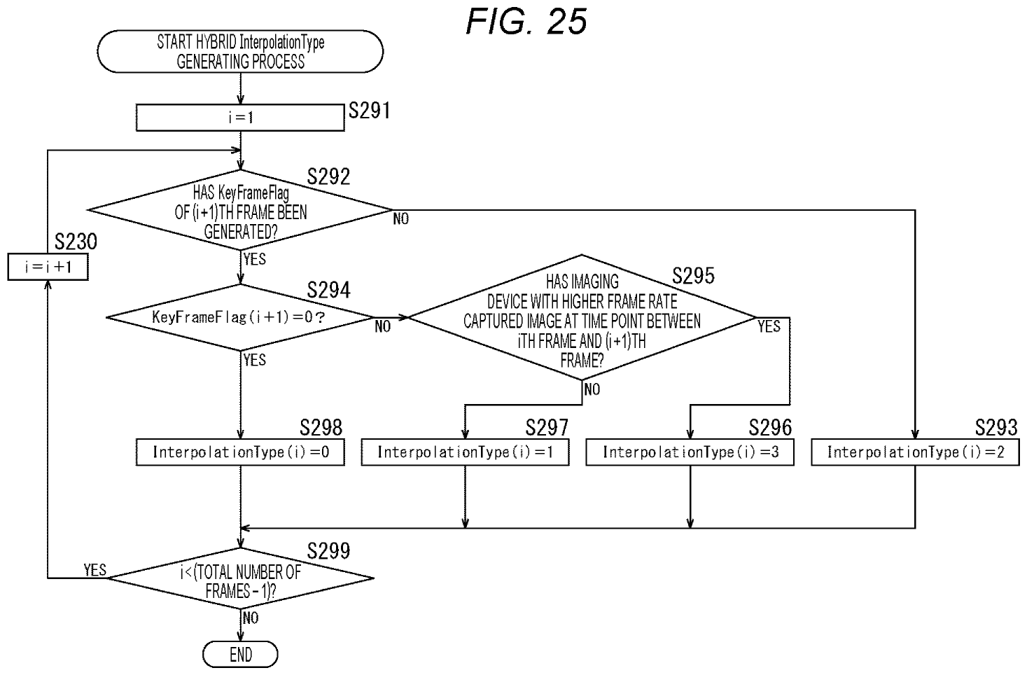

FIG. 25 illustrates a flowchart of an interpolation type generating process in a case where an interpolation type is used instead of a key frame flag in the fourth embodiment. It is assumed that this process is performed after the key frame flag generating process of FIG. 7, and the key frame flag of each frame is known.

First, in step S291, the flag generating device 12 sets a variable i indicating the frame number of the 3D data A with a lower frame rate to 0.

In step S292, the flag generating device 12 judges whether the key frame flag of the (i+1)th frame has been generated.

In a case where it is judged in step S292 that the key frame flag of the (i+1)th frame is not generated, the process proceeds to step S293, and the flag generating device 12 sets the interpolation type of the ith frame to “2” (Interpolation Type (i)=2), and the process proceeds to step S299.

In contrast, in a case where it is judged in step S292 that the key frame flag of the (i+1)th frame has been generated, the process proceeds to step S294, and the flag generating device 12 judges whether the key frame flag of the (i+1)th frame is “0”.

In step S294, in a case where it is judged that the key frame flag of the (i+1)th frame is not “0”, that is, the key frame flag of the (i+1)th frame is “1”, the process proceeds to step S295.

In step S295, the flag generating device 12 checks the 3D data B with the higher frame rate captured by the 3D modeling device 111, and judges whether the imaging device 10B with the higher frame rate captures an image at the time point between the ith frame and the (i+1)th frame of the 3D data A with the lower frame rate.

In a case where it is judged in step S295 that the imaging device 10B with the higher frame rate captures an image at the time point between the ith frame and the (i+1)th frame, the process proceeds to step S296 and the flag generating device 12 sets the interpolation type of the ith frame to “3” (Interpolation Type (i)=3), and the process proceeds to step S299.

In contrast, in a case where it is judged in step S295 that the imaging device 10B with the higher frame rate does not capture an image at the time point between the ith frame and the (i+1)th frame, the process proceeds to step S297 and the flag generating device 12 sets the interpolation type of the ith frame to “1” (Interpolation Type (i)=1), and the process proceeds to step S299.

In contrast, in a case where it is judged in step S294 that the key frame flag of the (i+1)th frame is “0”, the process proceeds to step S298, and the flag generating device 12 sets the interpolation type of the ith frame to “0” (Interpolation Type (i)=0), and the process proceeds to step S299.

In step S299, the flag generating device 12 judges whether the variable i indicating the frame number is smaller than (the total number of frames−1) of the 3D data A with the lower frame rate.

In a case where it is judged in step S299 that the variable i indicating the frame number is smaller than (the total number of frames−1) of the 3D data A, that is, in a case where it is judged that not all the interpolation types between all the frames of the 3D data A have not been determined, the process proceeds to step S230.

Then, in step S230, after the variable i indicating the frame number is incremented by 1, the process returns to step S292, and the above-described steps S292 to S299 are executed again. Therefore, the interpolation type of the next frame of the low frame rate 3D data A is determined.

In contrast, in a case where it is judged in step S207 that the variable i indicating the frame number is equal to or more than (the total number of frames−1) of the 3D data A, that is, the interpolation types between all the frames of the 3D data A are determined, the interpolation type generating process ends.

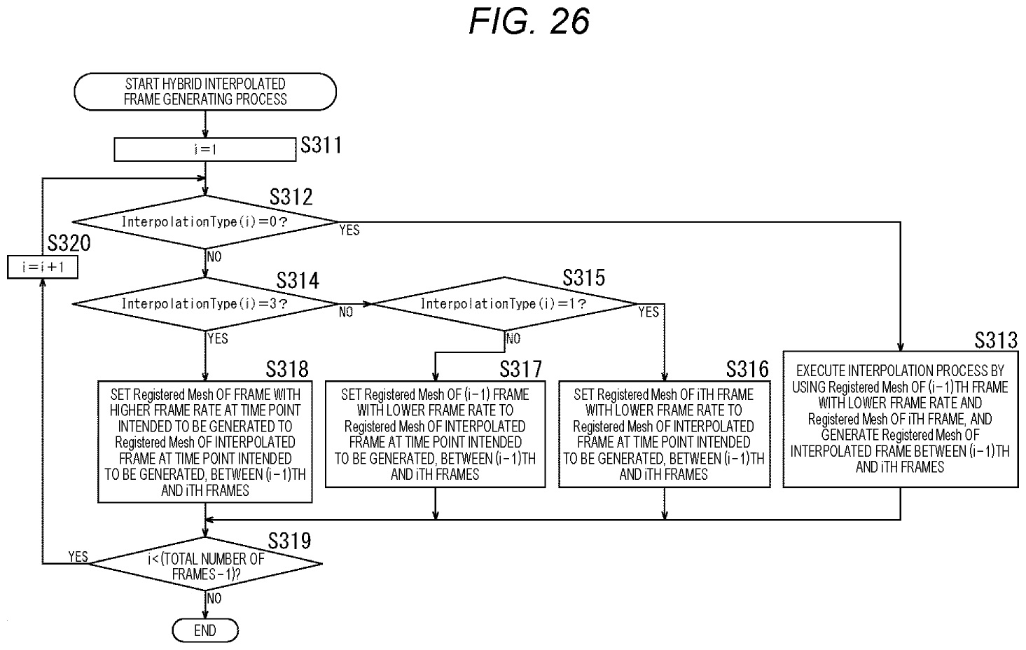

Next, a hybrid interpolated frame generating process in a case where an interpolation type is used will be described with reference to the flowchart of FIG. 26. This process is executed instead of the hybrid interpolated frame generating process in FIG. 24 in a case where the interpolation type is stored in the bit stream and transferred.

First, in step S311, the hybrid image generating device 120 sets the variable i indicating the frame number of 3D data A with the lower frame rate to 1.

In step S312, the hybrid image generating device 120 judges whether the interpolation type (the value of Interpolation Type (i)) of the ith frame of the 3D data A is “0”.

In a case where it is judged in step S312 that the interpolation type of the ith frame is “0”, the process proceeds to step S313.

In step S313, the hybrid image generating device 120 executes an interpolation process by using the R mesh of the (i−1)th frame and the R mesh of the ith frame of the 3D data A with the lower frame rate, generates the R mesh of the interpolated frame between the (i−1)th and ith frames, and the process proceeds to step S319.

In contrast, in a case where it is judged in step S312 that the interpolation type of the ith frame is not “0”, the process proceeds to step S314.

In step S314, the hybrid image generating device 120 judges whether the interpolation type (the value of Interpolation Type (i)) of the ith frame of the 3D data A is “3”.

In a case where it is judged in step S314 that the interpolation type of the ith frame is not “3”, the process proceeds to step S315, and the hybrid image generating device 120 judges whether the interpolation type of the ith frame (value of Interpolation Type (i)) is “1”.

In a case where it is judged in step S315 that the interpolation type of the ith frame (value of Interpolation Type (i)) is “1”, the process proceeds to step S316, the hybrid image generating device 120 copies the R mesh of the ith frame of the 3D data A with the lower frame rate, generates the R mesh of the interpolated frame at the time point intended to be generated, between the (i−1)th and ith frames, and the process proceeds to step S319.

In contrast, in a case where it is judged in step S315 that the interpolation type of the ith frame is not “1”, that is, the interpolation type of the ith frame is the process proceeds to step S317, the hybrid image generating device 120 copies the R mesh of the (i−1) frame of the 3D data A with the low frame rate, generates the R mesh of the interpolated frame at the time point intended to be generated, between the (i−1)th and ith frames, and the process proceeds to step S319.

In contrast, in a case where it is judged in step S314 that the interpolation type of the ith frame is “3”, the process proceeds to step S318, the hybrid image generating device 120 copies the R mesh of the frame between the (i−1)th and ith frames of the 3D data B with the higher frame rate, generates the R mesh of the interpolated frame at the time point intended to be generated, and the process proceeds to step S319.

In step S319, the hybrid image generating device 120 judges whether the variable i indicating the frame number of the 3D data A with the lower frame rate is smaller than (the total number of frames−1) of the 3D data A.

In a case where it is judged in step S319 that the variable i indicating the frame number is smaller than (the total number of frames−1) of the 3D data A, that is, in a case where it is judged that not all the interpolated frames between all the frames of the 3D data A have been generated, the process proceeds to step S320.

Then, in step S320, after the variable i indicating the frame number is incremented by 1, the process returns to step S312, and the above-described steps S312 to S319 are executed again. Therefore, the R mesh of the interpolated frame with the next frame is generated.

In contrast, in a case where it is judged in step S319 that the variable i indicating the frame number is equal to or more than (the total number of frames−1) of the 3D data A, that is, in a case where it is judged that interpolated frames between all the frames of the 3D data A are generated, the interpolated frame generating process ends.

As described above, even in the fourth embodiment using the two types of imaging devices 10A and 10B with different frame rates, the transmitting side can transmit the interpolation type instead of the key frame flag, and the receiving side can generate an interpolated frame between the received frames on the basis of the interpolation type.

<15. Fifth Embodiment of Image Processing System>

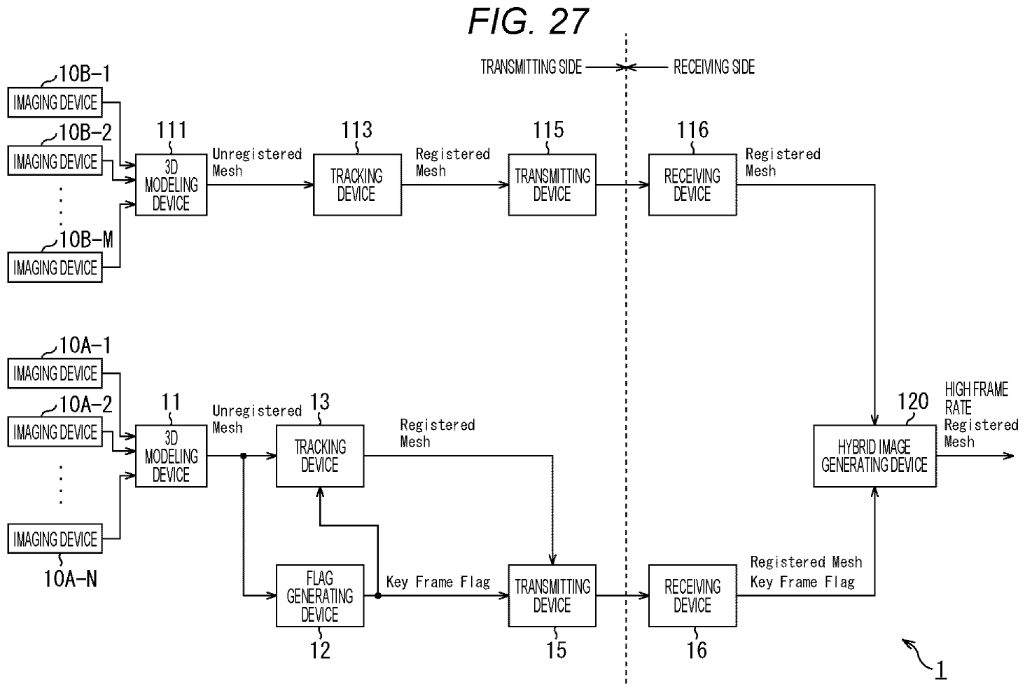

FIG. 27 is a block diagram illustrating a configuration example of a fifth embodiment of an image processing system to which the present technology is applied.

In FIG. 27, portions corresponding to those in the above-described fourth embodiment illustrated in FIG. 22 are denoted by the same reference signs, and description thereof will be omitted as appropriate.

The fifth embodiment of FIG. 27 has a configuration in which the coding device 114 and the decoding device 117 of the fourth embodiment using the two types of imaging devices 10A and 10B with different frame rates are omitted and the mesh data of each frame that is not compressed and coded is transferred.

Compared with the fourth embodiment illustrated in FIG. 22, in the fifth embodiment illustrated in FIG. 27, the coding devices 14 and 114 and the decoding device 17 and 117 are omitted similarly to the relationship between the above-described first embodiment and the second embodiment.

A tracking device 13 supplies a transmitting device 15 with an R mesh which is the mesh data subjected to a mesh tracking process. The transmitting device 15 causes the R mesh of each frame supplied from the tracking device 13 and the key frame flag of each frame supplied from the flag generating device 12 to be stored in one bit stream, and transmits the bit stream to a receiving device 16 via a network.

The receiving device 16 receives the bit stream of the 3D data A transmitted from the transmitting device 15 via the network. Then, the receiving device 16 separates the R mesh which is the mesh data of each frame and the key frame flag of each frame stored in the bit stream of the received 3D data A from each other, and supplies the mesh data and the key frame flag to a hybrid image generating device 120.

A tracking device 113 supplies the transmitting device 115 with the R mesh which is the mesh data subjected to a mesh tracking process. The transmitting device 115 causes the R mesh of each frame supplied from the tracking device 113 to be stored in one bit stream, and transmits the R mesh to the receiving device 116 via the network.

The receiving device 116 receives the bit stream of 3D data B transmitted from the transmitting device 15 via the network. Then, the receiving device 116 supplies the R mesh of each frame stored in the received 3D data B bit stream to a hybrid image generating device 120.

The hybrid image generating device 120 uses the R mesh of each frame supplied from the decoding device 17, the key frame flag of each frame supplied from the receiving device 16, and the R mesh of each frame supplied from the decoding device 117 to execute an interpolated frame generating process, and generates 3D data whose frame rate is up-converted.

<16. Sixth Embodiment of Image Processing System>

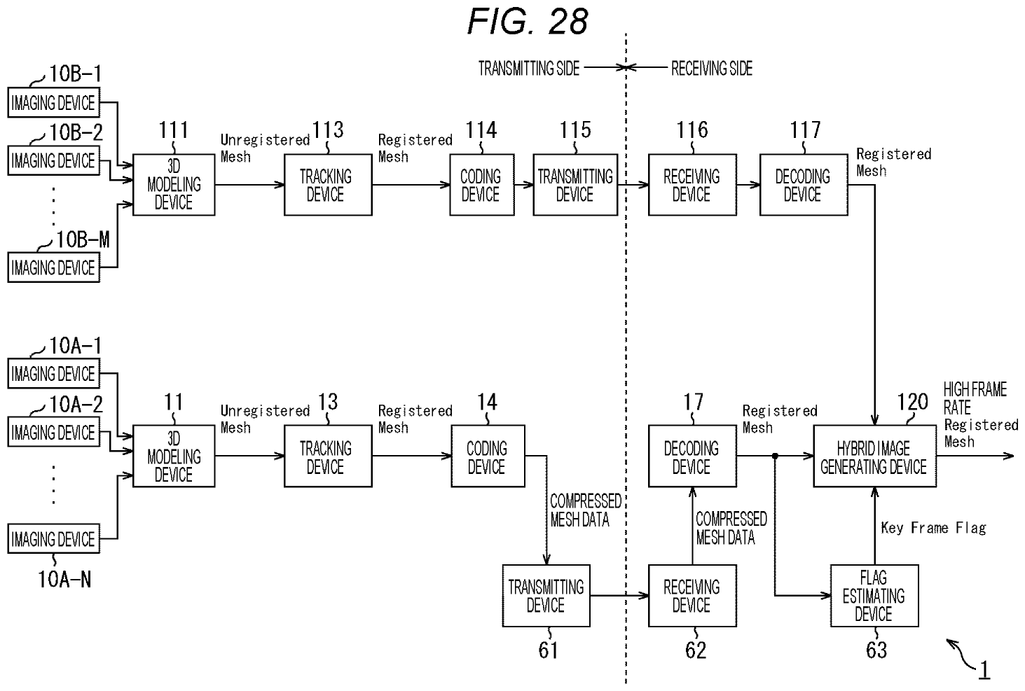

FIG. 28 is a block diagram illustrating a configuration example of a sixth embodiment of the image processing system to which the present technology is applied.

In FIG. 28, portions corresponding to those in the above-described first to fifth embodiments are denoted by the same reference signs, and description thereof will be omitted as appropriate.

The sixth embodiment in FIG. 28 has a configuration in which two types of imaging devices 10A and 10B having different frame rates are used, similarly to the above-described fourth and fifth embodiments.

Furthermore, similarly to the third embodiment illustrated in FIG. 20, the sixth embodiment of FIG. 28 has the configuration in which the receiving side determines (estimates) the key frame flag of each frame and generates the key frame flag without transmitting the key frame flag of each frame from the transmitting side.

In other words, the sixth embodiment of FIG. 28 has a configuration in which the flag generating device 12 on the transmitting side of the fourth embodiment using the two types of imaging devices 10A and 10B having different frame rates illustrated in FIG. 22 is omitted and the transmitting device 15 on the transmitting side of the fourth embodiment is replaced with the transmitting device 61 of the third embodiment, and the transmitting device 15 on the receiving side is replaced with the receiving device 62 of the third embodiment, and a flag estimating device 63 is newly added.

As described, even in a configuration using two types of imaging devices 10A and 10B having different frame rates, the transmitting side may not transmit the key frame flag of each frame, and the receiving side may determine (estimate) and generate the key frame flag of each frame to execute an interpolated frame generating process.

<17. Seventh Embodiment of Image Processing System>

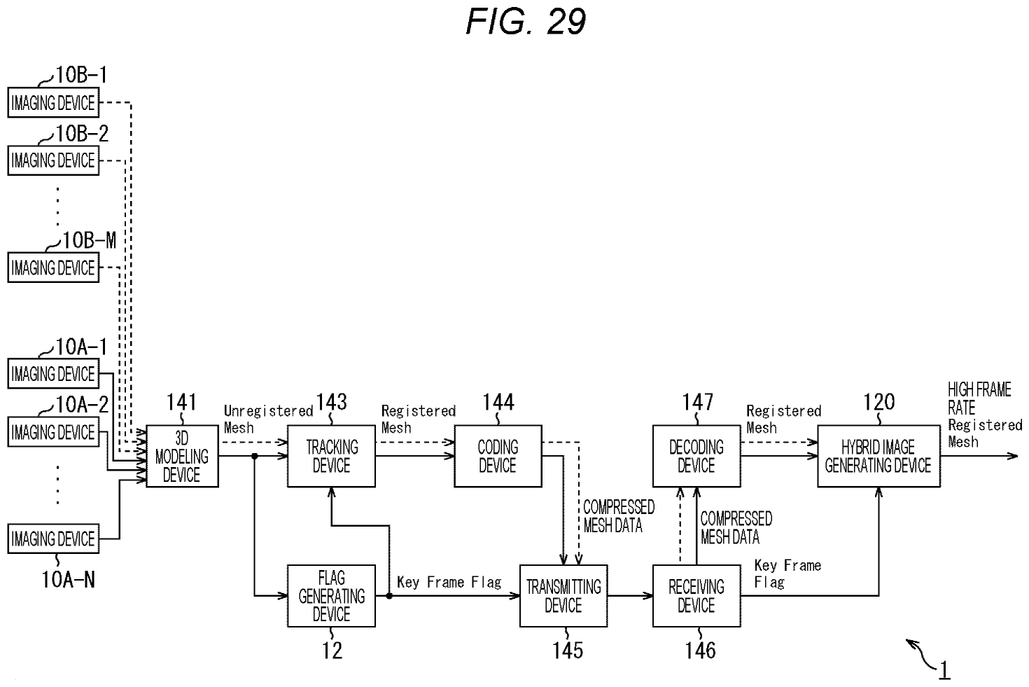

FIG. 29 is a block diagram illustrating a configuration example of a seventh embodiment of an image processing system to which the present technology is applied.

In FIG. 29, portions corresponding to those in the above-described first to sixth embodiments are denoted by the same reference signs, and description thereof will be omitted as appropriate.

An image processing system 1 according to a seventh embodiment has a configuration in which two types of imaging devices 10A and 10B having different frame rates are used, similarly to the above-described fourth to sixth embodiments.

In the image processing system 1 according to the above-described fourth to sixth embodiments, generation, transfer, and reception of mesh data of the 3D A with the lower frame rate, and generation, transfer, and reception of the mesh data of the 3D data B with the higher frame rate are performed by different devices.

However, as illustrated in FIG. 29, each device that generates, transfers, and receives mesh data of 3D data may be configured to process both 3D data A with the lower frame rate and the 3D data B with the higher frame rate.

The image processing system 1 in FIG. 29 includes a 3D modeling device 141, a tracking device 143, a coding device 144, a transmitting device 145, a receiving device 146, and a decoding device 147.

Furthermore, similarly to the fourth embodiment described above, the image processing system 1 of FIG. 29 includes a plurality of imaging devices 10A-1 to 10A-N, a plurality of imaging devices 10B-1 to 10B-M, a flag generating device 12, and a hybrid image generating device 120.

The 3D modeling device 141 performs both the process performed by the 3D modeling device 11 and the process performed by the 3D modeling device 111 described above. Specifically, the 3D modeling device 141 performs a 3D shape modeling process of a subject on the basis of a plurality of captured images obtained by the plurality of imaging devices 10A and 10B, respectively, and generates 3D data A and 3D data B obtained as a result.

The tracking device 143 performs both the process performed by the tracking device 13 and the process performed by the tracking device 113 described above. Specifically, the tracking device 143 performs a mesh tracking process on the U mesh of each frame supplied as 3D data A and B from the 3D modeling device 141, converts the U mesh into the R mesh of each frame, and supplies the R mesh to the coding device 144.

The coding device 144 performs both the process performed by the coding device 14 and the process performed by the coding device 114 described above. Specifically, the coding device 144 compresses and codes the R mesh of each frame as 3D data A and B supplied from the tracking device 143 by a predetermined coding system, and supplies compressed mesh data of each frame obtained as a result to the transmitting device 145.

The transmitting device 145 performs both the process performed by the transmitting device 15 and the process performed by the transmitting device 115 described above. Specifically, the transmitting device 145 causes the compressed mesh data of each frame as 3D data A and the key frame flag of each frame supplied from the flag generating device 12 to be stored, as a bit stream, in one bit stream, and transmits the bit stream to the receiving device 146 via a network. Furthermore, the transmitting device 145 causes the compressed mesh data of each frame as 3D data B to be stored in one bit stream, and transmits the bit stream to the receiving device 146 via the network.

The receiving device 146 performs both the process performed by the receiving device 16 and the process performed by the receiving device 116 described above. Specifically, the receiving device 146 receives the bit stream of the 3D data A transmitted from the transmitting device 145 via the network, and separates the compressed mesh data of each frame and the key frame flag of each frame from each other. Furthermore, the receiving device 146 receives the bit stream of the 3D data B transmitted from the transmitting device 145 via the network, and acquires the compressed mesh data of each frame. The compressed mesh data of each frame of the 3D data A and B is supplied to the decoding device 17, and the key frame flag of each frame is supplied to the hybrid image generating device 120.

The decoding device 147 performs both the process performed by the decoding device 17 and the process performed by the decoding device 117 described above. Specifically, the decoding device 147 decodes the compressed mesh data of each frame of the 3D data A and B supplied from the receiving device 146 by using a system corresponding to the coding system in the coding device 14, and supplies the decoded data to the hybrid image generating device 120.

The image processing system 1 can also be configured as described above.

<18. Eighth Embodiment of Image Processing System>

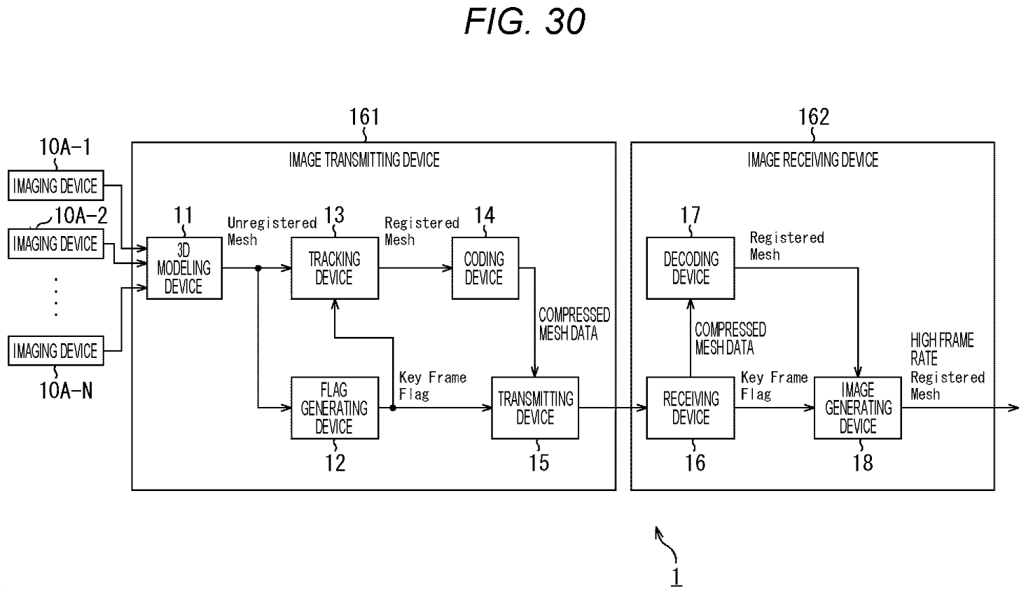

FIG. 30 is a block diagram illustrating a configuration example of an eighth embodiment of an image processing system to which the present technology is applied.

In FIG. 30, portions corresponding to those in the above-described first to sixth embodiments are denoted by the same reference signs, and description thereof will be omitted as appropriate.

The image processing system 1 according to the seventh embodiment is a modification of the first embodiment illustrated in FIG. 1.

In the first embodiment illustrated in FIG. 1, the 3D shape modeling process of a subject, the key frame flag generating process, the mesh tracking process, the compressing and coding process, and the key frame flag storing and transmitting process, the key frame flag receiving and separating processes, the decoding process, and the interpolated frame generating process are performed by different devices, respectively.

However, a configuration is possible in which on each the transmitting side and the receiving side, the plurality of devices described above is included in one device.

For example, as illustrated in FIG. 30, on the transmitting side, an image transmitting device 161 has a 3D modeling device 11, a flag generating device 12, a tracking device 13, a coding device 14, and a transmitting device 15 as an internal block. In the image transmitting device 161, the 3D modeling device 11, the flag generating device 12, the tracking device 13, the coding device 14, and the transmitting device 15 function as a 3D modeling unit, a flag generating unit (information generating unit), a tracking unit, a coding unit, and a transmitting unit, respectively.

On the receiving side, the image receiving device 162 has a receiving device 16, a decoding device 17, and an image generating device 18 as an internal block. The receiving device 16, the decoding device 17, and the image generating device 18 function as a receiving unit, a decoding unit, and an image generating unit in the image receiving device 162, respectively.

In this case, the image transmitting device 161 executes the processes performed by the 3D modeling device 11, the flag generating device 12, the tracking device 13, the coding device 14, and the transmitting device 15, respectively. The image receiving device 162 executes the processes performed by the receiving device 16, the decoding device 17, and the image generating device 18, respectively.

Note that the configuration illustrated in FIG. 30 is only an example, and a configuration in which any plurality of devices can be realized by one device may be employed. For example, a flag generating device 12, a tracking device 13, and a coding device 14 may constitute one device.

Furthermore, the configuration in FIG. 30 is a configuration in which a plurality of devices in the first embodiment illustrated in FIG. 1 is combined into one device; however, similarly, in the other embodiments described above, a configuration in which any plurality of devices can be realized by one device is possible.

<19. Computer Configuration Example>

The series of processes described above can be performed by hardware or can be performed by software. In a case where the series of processes are performed by software, a program that configures the software is installed on a computer. Here, examples of the computer include a microcomputer incorporated in dedicated hardware, for example, a general-purpose personal computer that can execute various functions by installing various programs, and the like.

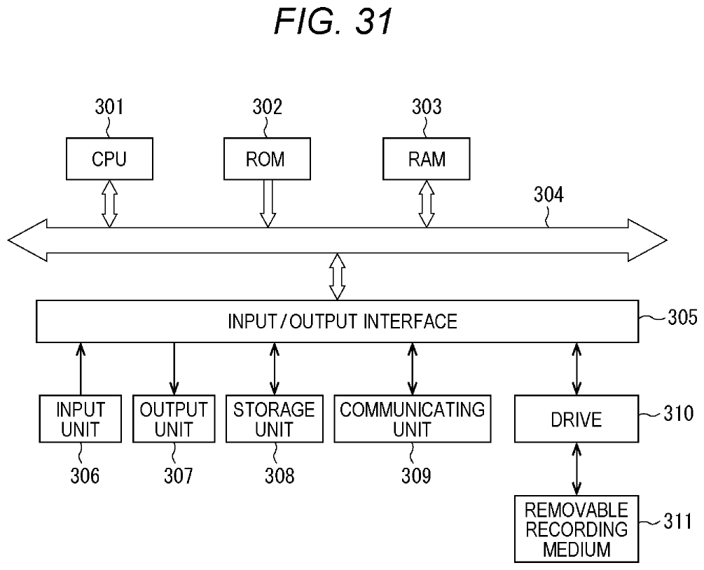

FIG. 31 is a block diagram illustrating an example of a hardware configuration of a computer that executes the series of processes described above according to a program.

In the computer, a central processing unit (CPU) 301, a read only memory (ROM) 302, and a random access memory (RAM) 303 are mutually connected by a bus 304.

Moreover, an input/output interface 305 is connected to the bus 304. An input unit 306, an output unit 307, a storage unit 308, a communication unit 309, and a drive 310 are connected to the input/output interface 305.

The input unit 306 includes a keyboard, a mouse, a microphone, a touch panel, an input terminal, or the like. The output unit 307 includes a display, a speaker, an output terminal, or the like. The storage unit 308 includes a hard disk, a RAM disk, a nonvolatile memory, or the like. The communication unit 309 includes a network interface or the like. The drive 310 drives a removable recording medium 311 such as a magnetic disk, an optical disk, a magneto-optical disk, or a semiconductor memory.

In the computer configured as described above, for example, the CPU 301 loads and executes the program stored in the storage unit 308 into the RAM 303 via the input/output interface 305 and the bus 304 and thus the above-described series of processes are performed. The RAM 303 also appropriately stores data or the like necessary for the CPU 301 to execute various processes.

In the computer, the program can be installed into the storage unit 308 via the input/output interface 305 by inserting the removable recording medium 311 into the drive 310. Furthermore, the program can be received by the communication unit 309 via a wired or wireless transfer medium such as a local area network, the Internet, or digital satellite broadcasting, and can be installed into the storage unit 308. In addition, the program can be installed in advance in the ROM 302 or the storage unit 308.

Note that in the present description, in addition to the case where the steps described in the flowcharts are performed in chronological order according to the described order, the steps may not be necessarily performed in chronological order and may be performed in parallel or at a necessary timing such as upon request.

Note that in the present description, a system means a set of a plurality of constituents (devices, modules (components), or the like), and it does not matter whether or not all the constituents are in the same case. Therefore, each of a plurality of devices housed in separate cases and connected via a network, and one device in which a plurality of modules is housed in one case is a system.

The embodiments of the present technology are not limited to the above-described embodiments, and various modifications can be made without departing from the scope of the present technology.

For example, a mode in which all or some of the plurality of embodiments described above are combined may be adopted.

For example, the present technology can adopt a configuration of cloud computing in which one function is shared and processed jointly by a plurality of devices via a network.

Furthermore, each step described in the above-described flowchart can be executed by one device, or can be shared and executed by a plurality of devices.

Moreover, in a case where a plurality of processes is included in one step, the plurality of processes included in the one step can be shared and executed by a plurality of devices in addition to being executed by one device.

Note that the effects described in the present description is an illustration only and not limited, and may have effects other than the effects described in the present description.

Note that the present technology can also be configured as follows.

(1)

A transmitting device including:

an information generating unit that generates information based on degree of difference between two frames of a 3D image; and

a transmitting unit that transmits the information based on the degree of difference generated.

(2)

The transmitting device according to the (1), in which the information based on the degree of difference is a flag indicating whether or not a 3D shape changes significantly between the two frames.

(3)

The transmitting device according to the (1), in which the information based on the degree of difference is a value indicating an interpolation type in a case where a frame between the two frames is generated.

(4)

The transmitting device according to the (1), in which the information based on the degree of difference is a value of the degree of difference between the two frames.

(5)

The transmitting device according to any one of the (1) to (4), in which the transmitting unit generates and transmits a bit stream in which mesh data of the two frames of the 3D image and the information based on the degree of difference are stored.

(6)

The transmitting device according to the (5), in which the transmitting unit generates and transmits a bit stream in which information based on the degree of difference is stored as metadata for each frame.

(7)

The transmitting device according to the (5), in which the transmitting unit generates and transmits a bit stream that stores metadata in which information based on the degree of difference of all frames of the 3D image is stored, and each of the all frames of the 3D image.

(8)

The transmitting device according to any one of the (1) to (4), further including a coding unit that compresses and codes the mesh data of the two frames of the 3D image by using a predetermined coding system, in which the transmitting unit generates and transmits a bit stream in which compressed mesh data obtained by compressing and coding the mesh data and the information based on the degree of difference are stored.

(9)

The transmitting device according to any one of the (1) to (4),

in which the information generating unit generates information based on the degree of difference of the 3D image at a first frame rate, and

the transmitting unit transmits mesh data of the 3D image with the first frame rate and the information based on the degree of difference, and mesh data of a 3D image obtained by imaging a same subject at a second frame rate different from the first frame rate.

(10)

A transmitting method including:

generating, by a transmitting device, information based on degree of difference between two frames of a 3D image; and

transmitting, by the transmitting device, the information based on the degree of difference generated.

(11)

A receiving device including an image generating unit that generates an interpolated frame between two frames of a 3D image on the basis of information based on degree of difference between the two frames.

(12)

The receiving device according to the (11), in which the information based on the degree of difference is a flag indicating whether or not a 3D shape changes significantly between the two frames.

(13)

The receiving device according to the (11), in which the information based on the degree of difference is a value indicating an interpolation type in a case where the interpolated frame is generated.

(14)

The receiving device according to the (11), in which the information based on the degree of difference is a value of the degree of difference between the two frames.

(15)

The receiving device according to any one of the (11) to (14), in which the image generating unit changes a generating method of generating the interpolated frame on the basis of the information based on the degree of difference.

(16)

The receiving device according to any one of the (11) to (15), in which the degree of difference is a value obtained by calculating Hausdorff distance between the two frames.

(17)

The receiving device according to any one of the (11) to (16), further including a receiving unit that receives a bit stream which stores mesh data of the two frames of the 3D image and the information based on the degree of difference,

in which the image generating unit generates the interpolated frame on the basis of the information based on the degree of difference received.

(18)

The receiving device according to the (17), in which the mesh data of the two frames of the 3D image is compressed and coded by using a predetermined coding system,

the receiving device further includes a decoding unit that decodes the mesh data that is compressed and coded, and

the image generating unit generates the interpolated frame by using the mesh data obtained by decoding, on the basis of the information based on the degree of difference received.

(19)

The receiving device according to the (17) or (18), in which the receiving unit receives the bit stream in which the information based on the degree of difference is stored as metadata for each frame.

(20)

The receiving device according to the (17) or (18), in which the receiving unit receives a bit stream that stores metadata in which information based on the degree of difference of all frames of the 3D image is stored, and mesh data of each of the all frames of the 3D image.

### REFERENCE SIGNS LIST

1 Image processing system
10A, 10B Imaging device
11 3D modeling device
12 Flag generating device
13 Tracking device
14 Coding device
Transmitting device
16 Receiving device
17 Decoding device
18 Image generating device
61 Transmitting device
62 Receiving device
63 Flag estimating device
111 3D modeling device
113 Tracking device
114 Coding device
115 Transmitting device
116 Receiving device
117 Decoding device
120 Hybrid image generating device
141 3D modeling device
143 Tracking device
144 Coding device
145 Transmitting device
146 Receiving device
147 Decoding device
161 Image transmitting device
162 Image receiving device
301 CPU
302 ROM
303 RAM
306 Input unit
307 Output unit
308 Storage unit
309 Communication unit
310 Drive

1. A transmitting device comprising:
an information generating unit that generates information based on degree of difference between two frames of a 3D image; and
a transmitting unit that transmits the information based on the degree of difference generated.

2. The transmitting device according to claim 1, wherein the information based on the degree of difference is a flag indicating whether or not a 3D shape changes significantly between the two frames.

3. The transmitting device according to the claim 1, wherein the information based on the degree of difference is a value indicating an interpolation type in a case where a frame between the two frames is generated.

4. The transmitting device according to claim 1, wherein the information based on the degree of difference is a value of the degree of difference between the two frames.

5. The transmitting device according to claim 1, wherein the transmitting unit generates and transmits a bit stream in which mesh data of the two frames of the 3D image and the information based on the degree of difference are stored.

6. The transmitting device according to claim 5, wherein the transmitting unit generates and transmits a bit stream in which information based on the degree of difference is stored as metadata for each frame.

7. The transmitting device according to claim 5, wherein the transmitting unit generates and transmits a bit stream that stores metadata in which information based on the degree of difference of all frames of the 3D image is stored, and each of the all frames of the 3D image.

8. The transmitting device according to claim 1, further comprising a coding unit that compresses and codes mesh data of the two frames of the 3D image by using a predetermined coding system,
wherein the transmitting unit generates and transmits a bit stream that stores compressed mesh data obtained by compressing and coding the mesh data and information based on the degree of difference.

9. The transmitting device according to claim 1,
wherein the information generating unit generates information based on the degree of difference of the 3D image with a first frame rate, and
the transmitting unit transmits mesh data of the 3D image with the first frame rate and the information based on the degree of difference, and mesh data of a 3D image obtained by imaging a same subject at a second frame rate different from the first frame rate.

10. A transmitting method comprising:
generating, by a transmitting device, information based on degree of difference between two frames of a 3D image; and
transmitting, by the transmitting device, the information based on the degree of difference generated.

11. A receiving device comprising an image generating unit that generates an interpolated frame between two frames of a 3D image on a basis of information based on degree of difference between the two frames.

12. The receiving device according to claim 11, wherein the information based on the degree of difference is a flag indicating whether or not a 3D shape changes significantly between the two frames.

13. The receiving device according to claim 11, wherein the information based on the degree of difference is a value indicating an interpolation type in a case where the interpolated frame is generated.

14. The receiving device according to claim 11, wherein the information based on the degree of difference is a value of the degree of difference between the two frames.

15. The receiving device according to claim 11, wherein the image generating unit changes a generating method of generating the interpolated frame on a basis of the information based on the degree of difference.

16. The receiving device according to claim 11, wherein the degree of difference is a value obtained by calculating Hausdorff distance between the two frames.

17. The receiving device according to claim 11, further comprising a receiving unit that receives a bit stream which stores mesh data of the two frames of the 3D image and the information based on the degree of difference,
wherein the image generating unit generates the interpolated frame on a basis of the information based on the degree of difference received.

18. The receiving device according to claim 17,
wherein the mesh data of the two frames of the 3D image is compressed and coded by using a predetermined coding system,
the receiving device further comprises a decoding unit that decodes the mesh data that is compressed and coded, and
the image generating unit generates the interpolated frame by using the mesh data obtained by decoding, on a basis of the information based on the degree of difference received.

19. The receiving device according to claim 17, wherein the receiving unit receives the bit stream in which the information based on the degree of difference is stored as metadata for each frame.

20. The receiving device according to claim 17, wherein the receiving unit receives a bit stream that stores metadata in which information based on the degree of difference of all frames of the 3D image is stored, and mesh data of each of the all frames of the 3D image.
